(19) United States
(12) Patent Application Publication
(10) Pub. No.: US 2026/0173030 A1
(43) Pub. Date: Jun. 18, 2026

(54) SYSTEMS AND METHODS FOR PAGING WITH MEASUREMENT REPORTING

(71) Applicant: Huawei Technologies Co., Ltd., Shenzhen (CN)

(72) Inventors: Liqing Zhang, Ottawa (CA); Jianglei Ma, Ottawa (CA)

(21) Appl. No.: 19/536,799

(22) Filed: Feb. 11, 2026

Related U.S. Application Data
(63) Continuation of application No. PCT/CN2023/139515, filed on Dec. 18, 2023.
(60) Provisional application No. 63/519,078, filed on Aug. 11, 2023.

(51) Int. Cl. H04W 68/00; H04W 72/23

(52) U.S. Cl. CPC H04W 68/00; H04W 68/005; H04W 72/23

(57) ABSTRACT

In wireless communication, a user equipment (UE) may be configured to have lower-power sleep periods as well as wake-up periods. During a wake-up period, the UE may perform a paging operation that involves synchronization, monitoring for and decoding a paging notification that schedules a paging message, and receiving and decoding the paging message. When performing the paging operation, the UE has an opportunity to measure one or more properties of the wireless channel. In some embodiments, a UE is configured to measure a channel property using a downlink signal during a paging operation and report the measurement.

### CROSS REFERENCE TO RELATED APPLICATIONS

This application is a continuation of International Patent Application No. PCT/CN2023/139515, filed on Dec. 18, 2023, which claims priority to and the benefit of U.S. Provisional Patent Application No. 63/519,078, filed on Aug. 11, 2023, all of which are hereby incorporated herein by reference in their entirety.

### TECHNICAL FIELD

The present application relates to wireless communication, and more specifically to measuring and reporting in association with paging.

### BACKGROUND

In some wireless communication systems, electronic devices, such as user equipments (UEs), wirelessly communicate with a wireless network via one or more transmit-and-receive points (TRPs). A TRP may be a terrestrial TRP (T-TRP) or non-terrestrial TRP (NT-TRP). An example of a T-TRP is a stationary base station or Node B. An example of a NT-TRP is a TRP that can move through space to relocate, e.g. a TRP mounted on a drone, plane, and/or satellite, etc.

A wireless communication from a UE to one or more TRPs is referred to as an uplink communication. A wireless communication from one or more TRPs to a UE is referred to as a downlink communication. Resources are required to perform uplink and downlink communications. For example, a UE may wirelessly transmit data to a TRP in an uplink communication over a particular frequency (or range of frequencies) for a particular duration of time. The frequency and time duration are examples of resources, typically referred to as time-frequency resources. Other examples of resources may include resources in the spatial domain (e.g. the beam that is used), resources in the power domain (e.g. transmission power), etc.

A UE or a group of UEs may each be configured to have sleep periods during which the UE is in a lower-power sleep mode, as well as wake-up periods, e.g. based on a discontinuous reception (DRX) cycle. During a wake-up period, the UE or group of UEs may each be configured to perform a paging operation to determine whether the UE has been paged to receive data from the network. A paging operation may involve downlink synchronization, monitoring for and decoding a paging notification that schedules a paging message, and receiving and decoding the paging message. The paging message may indicate which UEs have been paged. The network may page a UE in the paging message when the network has data to transmit to that UE. “Data”, as used herein, may be interchangeably called information, and it may encompass traffic and/or control information.

When performing the paging operation, the UE only implements the necessary steps to determine whether it has been paged, e.g. synchronizing, receiving the paging notification, and receiving the paging message. The UE does not take the opportunity to supplement the paging operation with additional steps unrelated to the paging.

### SUMMARY

When performing a paging operation, the UE has an opportunity to measure one or more properties of the wireless channel. In some instances, it might be the case that some sort of measurement is performed by the UE as part of implementing one or more steps of the paging operation, e.g. when the UE performs downlink synchronization. However, that measurement is not reported to the TRP in any circumstances, whether or not the UE is being paged. More generally, the UE has the opportunity during a paging operation to measure, for example, one or more channel properties that are not needed to implement the paging operation and are not currently measured during the paging operation. For example, when receiving the synchronization signal to perform downlink synchronization, prior to monitoring for the paging notification, the UE could measure the signal-to-noise ratio (SNR) of the synchronization signal to obtain an indication of channel quality, even though this is not needed to synchronize and subsequently receive the paging notification and paging message. However, the UE does not currently perform such measurements, let alone report them to the TRP. Configuring the UE to measure one or more channel properties, such as SNR, during a paging operation and reporting the measurement to the TRP may provide useful information to the network. The information provided to the network by the UE may be used by the network for more effective control and operation. For example, information provided to the network by the UE may be used by the network to improve the quality and/or efficiency of communications in the network. As an example, the network may use the reported measurement from each UE to determine which UEs have a channel with high-SNR, so that the network can communicate with those UEs using lower power. As another example, if the measurements are per-beam measurements (indicating, for example, which beams have highest received channel quality), the network may use the reported measurement to infer the location of each UE, e.g. by inferring that a UE is in the direction of the beam with highest reported channel quality. Knowing the location of the UEs has advantages, e.g. UEs that are spatially separated can be scheduled on overlapping time-frequency resources and/or UEs in locations where sensing is desired can be configured to perform the sensing.

In some embodiments herein, one or more UEs are configured to measure at least one channel property using a downlink signal during a paging operation. The downlink signal may be, for example, a synchronization signal (e.g. in a synchronization signal block (SSB)) or a demodulation reference signal (DMRS) (e.g. in a control channel that carries a paging notification or in a data channel that carries a paging message). The at least one channel property measured by the UE may be, for example, reference signal received power (RSRP), and/or reference signal received quality (RSRQ), and/or signal-to-noise ratio (SNR), and/or signal-to-interference-and-noise ratio (SINR), and/or channel quality, and/or Doppler shift, and/or Doppler spread, and/or average delay, and/or or delay spread. The UE may be configured to report the result of the measurement to the TRP, even if the UE is not paged. For example, the UE may be configured to report the result during the wake-up period during which the paging operation was performed, before the UE goes back to sleep.

Technical benefits of some embodiments include the ability to measure one or more properties of the wireless channel using a downlink signal already transmitted for the purposes of the paging operation, and report the measurement result to the network, which the network may then use for more effective or optimized control and operation. The paging operation is supplemented with the measurement and reporting. By using a downlink signal already transmitted for the purposes of the paging operation, the UE may implement the measurement and reporting as part of the paging operation without as much overhead compared to configuring a separate occasion (different from a paging occasion) during which a dedicated downlink signal must be sent to the UE for measuring and reporting.

Embodiments are not limited to a TRP and UE, but instead apply more generally to situations in which the network is paging an entity that is communicating with the network. For example, instead of a UE, a NT-TRP may be paged and may perform the measurement and reporting. The TRP paging the NT-TRP transmits the downlink signal as part of paging, although in this scenario the downlink signal from the network might be wirelessly transmitted over a link that is considered a backhaul link, depending upon the implementation. As another example, instead of a TRP, a “master UE” operating on behalf of the network may page other UEs and send the downlink signal. In this scenario, the downlink signal from the master UE might be wirelessly transmitted over a link that is considered a sidelink, depending upon the implementation. In view of the foregoing, more generally, the methods may be performed by an apparatus and a device, where “apparatus” and “device” are simply different labels to more easily distinguish between two entities. Also, more generally, the “downlink signal” may be any signal that is received by the entity being paged during the paging operation.

In one aspect, there is provided a method performed by an apparatus (e.g. a UE). The method may include waking from a sleep mode to perform a paging operation. During the paging operation, the method may include measuring at least one channel property using a downlink signal. The method may further include transmitting information to a device based on the measured at least one channel property. In some embodiments, the transmitting occurs without the apparatus being paged. That is, even if the apparatus is not paged the apparatus may be configured to measure the at least one channel property and transmit the information based on the measured at least one channel property. In some embodiments, the apparatus is a user equipment (UE) and the device is a transmit-and-receive point (TRP) in a wireless communication system.

In some embodiments, measuring the at least one channel property using the downlink signal may include measuring at least one of the following using the downlink signal: reference signal received power (RSRP); reference signal received quality (RSRQ); signal-to-noise ratio (SNR); signal-to-interference-and-noise ratio (SINR); channel quality; Doppler shift; Doppler spread; average delay; or delay spread.

In some embodiments, the information based on the measured at least one channel property may include at least one of: an indication of the measured at least one channel property; or a report (e.g. CSI report) derived from the measured at least one channel property.

In some embodiments, prior to measuring the at least one channel property, the method may include receiving a message configuring the at least one channel property to be measured. In some embodiments, the message may be received in at least one of: radio resource control (RRC) signaling; a medium access control (MAC) control element (MAC-CE); a synchronization signal block (SSB); system information (SI); a downlink control information (DCI); a low-power wakeup signal (LP-WUS); or a paging notification.

In some embodiments, the downlink signal may be received on a first beam, and the method may include performing per-beam measurement during the paging operation. In some embodiments, the per-beam measurement may be performed by: measuring the at least one channel property for the first beam using the downlink signal received on the first beam; and for each beam of one or more other beams: receiving a corresponding downlink signal on that beam and measuring the at least one channel property for that beam using the corresponding downlink signal received on that beam. In some embodiments, the information transmitted may be based on the measured at least one channel property for the first beam and the measured at least one channel property for each of the one or more other beams. In some embodiments, the information transmitted may include an indication of one or more beams that have a measured channel property.

In some embodiments, multiple downlink signals, including the downlink signal, may be received during the paging operation. In some embodiments, the multiple downlink signals may have a quasi co-location (QCL) relationship with each other. In some embodiments, measuring the at least one channel property may include measuring the at least one channel property using at least one of the multiple downlink signals.

In some embodiments, the paging operation may be associated with a paging occasion during a wake-up period. In some embodiments, transmitting the information may include transmitting the information during the wake-up period. In some embodiments, the method may include receiving a message configuring one or more paging operations. For example, the message may configure the one or more paging operations by at least configuring at least one of: one or more wake-up periods; one or more sleep periods; a paging discontinuous reception (DRX) cycle; or one or more paging occasions in a wake-up period. In some embodiments, the message further configures at least one of: one or more wake-up periods during which the apparatus is to transmit the information based on the measured at least one channel property; one or more paging occasions for which the apparatus is to transmit the information; the at least one channel property that is to be measured; which one or more channel properties are to be reported as part of the information; a manner in which the information is to be transmitted; or uplink time-frequency resources used to transmit the information. In some embodiments, the message may configure the one or more paging operations by at least configuring at least one of: one or more wake-up periods; one or more sleep periods; a paging discontinuous reception (DRX) cycle; or one or more paging occasions in a wake-up period. In some embodiments, the message is received in at least one of: RRC signaling; a MAC-CE; a DCI; an SSB; SI; or, an LP-WUS.

In some embodiments, the method may include receiving a message that configures the apparatus to transmit the information during the wake-up period. In some embodiments, the message may be received in at least one of: RRC signaling; a MAC-CE; a DCI; an SSB; SI, a LP-WUS; a paging notification; or a paging message. In some embodiments, the message may also indicate at least one of: whether the apparatus is to perform sensing; or whether the apparatus is being paged.

In some embodiments, transmitting the information may include at least one of: transmitting the information in an uplink control channel; transmitting the information in an uplink data channel; transmitting the information during a random access procedure; transmitting the information in a wake up signal (WUS); or transmitting the information in an uplink reference signal. In some embodiments, the information may be transmitted in the WUS by transmitting one of multiple WUS transmission sequences. In some embodiments, the information may be transmitted in the uplink reference signal by transmitting one of multiple sounding reference signal (SRS) sequences. In some embodiments, the information may be transmitted in the uplink data channel along with an uplink data transmission. In some embodiments, uplink time-frequency resources used to transmit the information may be indicated in at least one of: RRC signaling; a MAC-CE; an SSB; SI; a DCI; an LP-WUS; a paging notification; or a paging message.

In some embodiments, the downlink signal may be or include a synchronization signal (SS). In some embodiments, the method may include synchronizing with the SS prior to receiving a paging notification. In some embodiments, the SS may include at least one of: an SS in an SSB; an SS that is not in an SSB; a low power synchronization signal (LP-SS); or a reference signal. In some embodiments, the SSB or the LP-SS may indicate at least one of: whether paging will occur for a wake-up period; or one or more aggregation levels (ALs) for a downlink control channel used to receive a paging notification.

In some embodiments, the downlink signal may be or include a demodulation reference signal (DMRS). In some embodiments, the DMRS may be received in one of: an SSB that serves as synchronization and carries system information bits; or a control channel that carries a paging notification; or a data channel that carries a paging message.

In some embodiments, the downlink signal may be or include a sensing signal used by the apparatus for a sensing operation.

In some embodiments, the method may include receiving a paging notification during the paging operation. In some embodiments, the paging notification may indicate at least one of: a time-frequency resource allocation for transmitting the information; which one or more channel properties are to be reported as part of the information; or one or more ALs to be used for a subsequent downlink control channel transmission.

In some embodiments, the method may include receiving a paging message during the paging operation. In some embodiments, the paging message may include apparatus-specific information indicating whether or not the apparatus has been paged. In some embodiments, the paging message may additionally include at least one of the following that is common for a plurality of apparatuses: a time-frequency resource allocation for transmitting the information; an indication of which one or more channel properties are to be reported as part of the information; an indication of one or more ALs to be used for a subsequent downlink control channel transmission; sensing information related to a sensing operation; quasi co-location (QCL) reference signal information; or an indication of timing adjustment (TA) for an uplink transmission.

In some embodiments, the method may include receiving a LP-WUS or a reference signal that at least one of: triggers the apparatus to switch to a different transceiver; indicates a location of time-frequency resources in a downlink control channel used to receive a paging notification; or indicates one or more ALs for the downlink control channel used to receive the paging notification.

In some embodiments, the transmitting information to a device occurs without the apparatus being paged.

In some embodiments, an apparatus (e.g. a UE) is provided to perform any of the methods. For example, the apparatus may include at least one processor and a memory storing processor-executable instructions that, when executed by the at least one processor, cause the apparatus to perform any of the methods. For example, the processor-executable instructions, when executed by the at least one processor, may cause the apparatus to: wake from a sleep mode to perform a paging operation; during the paging operation, measure at least one channel property using a downlink signal; and transmit information based on the measured at least one channel property. In some embodiments, the apparatus is a chip, e.g. an integrated circuit (IC) chip. In some embodiments, the apparatus does not execute instructions by a processor to perform the methods, e.g. the apparatus may comprise circuitry such as a field-programmable gate array (FPGA), a graphical processing unit (GPU), or an application-specific integrated circuit (ASIC), that performs the methods. More generally, the apparatus may comprise modules or units to perform the methods, e.g. a unit or module to wake from a sleep mode to perform a paging operation, a unit or module to, during the paging operation, measure at least one channel property using a downlink signal, and a unit or module to transmit information based on the measured at least one channel property. In some embodiments, the apparatus may include means for performing the method steps, e.g. the apparatus may comprise a means to wake from a sleep mode to perform a paging operation, a means to, during the paging operation, measure at least one channel property using a downlink signal, and a means to transmit information based on the measured at least one channel property.

According to an aspect of the present disclosure, there is provided an apparatus. The apparatus includes a control unit configured to wake the apparatus from a sleep mode to perform a paging operation. The apparatus further includes a measurement unit configured to measure at least one channel property using a downlink signal during the paging operation. The apparatus further includes a communication unit configured to transmit information to a device based on the measured at least one channel property.

In another aspect, there is provided a method performed by a device, e.g. a network device such as a TRP. The method may include transmitting a downlink signal during a paging operation. The method may further include receiving information from an apparatus. The information may be based on at least one channel property that was measured by the apparatus using the downlink signal. In some embodiments, the information may be received from the apparatus without the apparatus being paged. That is, even if the apparatus is not paged by the device the apparatus may still be configured to measure the at least one channel property and transmit the information based on the measured at least one channel property, such that the information is received by the device in relation to that paging operation. In some embodiments, the apparatus is a user equipment (UE) and the device is a transmit-and-receive point (TRP) in a wireless communication system.

In some embodiments, the at least one channel property that was measured may include at least one of: reference signal received power (RSRP); reference signal received quality (RSRQ); signal-to-noise ratio (SNR); signal-to-interference-and-noise ratio (SINR); channel quality; Doppler shift; Doppler spread; average delay; or delay spread.

In some embodiments, the information based on the at least one channel property that was measured may include at least one of: an indication of the measured at least one channel property; or a report derived from the measured at least one channel property.

In some embodiments, the method may include transmitting a message configuring the at least one channel property to be measured. In some embodiments, the message may be transmitted in at least one of: radio resource control (RRC) signaling; a medium access control (MAC) control element (MAC-CE); a synchronization signal block (SSB); system information (SI); a downlink control information (DCI); a low-power wakeup signal (LP-WUS); or a paging notification.

In some embodiments, the downlink signal may be transmitted on a first beam, and a corresponding downlink signal may be transmitted on each beam of one or more other beams. In some embodiments, the information received from the apparatus may be based on the at least one channel property measured by the apparatus for the first beam and the at least one channel property measured by the apparatus for each of the one or more other beams. In some embodiments, the information received may include an indication of one or more beams that have a measured channel property.

In some embodiments, multiple downlink signals, including the downlink signal, may be transmitted during the paging operation. In some embodiments, the multiple downlink signals may have a quasi co-location (QCL) relationship with each other. In some embodiments, the at least one channel property that was measured by the apparatus may have been measured using at least one of the multiple downlink signals.

In some embodiments, the paging operation may be associated with a paging occasion during a wake-up period of the apparatus. In some embodiments, the information may have been transmitted during the wake-up period. In some embodiments, the method may include transmitting a message configuring one or more paging operations. For example, the message may configure the one or more paging operations by at least configuring at least one of: one or more wake-up periods; one or more sleep periods; a paging discontinuous reception (DRX) cycle; or one or more paging occasions in a wake-up period. In some embodiments, the message may further configure at least one of: one or more wake-up periods during which the apparatus is to transmit the information based on the measured at least one channel property; one or more paging occasions for which the apparatus is to transmit the information; the at least one channel property that is to be measured; which one or more channel properties are to be reported as part of the information; a manner in which the information is to be transmitted; or uplink time-frequency resources used to transmit the information. In some embodiments, the message may be transmitted in at least one of: RRC signaling; a MAC-CE; a DCI; an SSB; SI; or, an LP-WUS.

In some embodiments, the method may include transmitting a message that configures the apparatus to transmit the information during the wake-up period. In some embodiments, the message may be transmitted in at least one of: RRC signaling; a MAC-CE; a DCI; an SSB; SI, an LP-WUS; a paging notification; or a paging message. In some embodiments, the message may also indicate at least one of: whether the apparatus is to perform sensing; or whether the apparatus is being paged.

In some embodiments, the information may be at least one of: received in an uplink control channel; received in an uplink data channel; received during a random access procedure; received in a wake up signal (WUS); or received in an uplink reference signal. In some embodiments, the information may be received in the WUS by receiving one of multiple WUS transmission sequences. In some embodiments, the information may be received in the uplink reference signal by receiving one of multiple sounding reference signal (SRS) sequences. In some embodiments, the information may be received in the uplink data channel along with an uplink data transmission. In some embodiments, the uplink time-frequency resources used to receive the information may be indicated, by the device to the apparatus, in at least one of: RRC signaling; a MAC-CE; an SSB; SI; a DCI; an LP-WUS; a paging notification; or a paging message.

In some embodiments, the downlink signal may be or include a synchronization signal (SS) to be used by the apparatus for synchronization. In some embodiments, the SS may be at least one of: an SS in an SSB; an SS that is not in an SSB; a low power synchronization signal (LP-SS); or a reference signal. In some embodiments, the SSB or the LP-SS may indicate at least one of: whether paging will occur for a wake-up period; or one or more aggregation levels (ALs) for a downlink control channel used to transmit a paging notification.

In some embodiments, the downlink signal may be or include a demodulation reference signal (DMRS). In some embodiments, the DMRS may be transmitted in one of: an SSB that serves as synchronization and carries system information bits; or a control channel that carries a paging notification; or a data channel that carries a paging message.

In some embodiments, the downlink signal may be or include a sensing signal to used by the apparatus for a sensing operation.

In some embodiments, the method may include transmitting a paging notification during the paging operation. In some embodiments, the paging notification may indicate at least one of: a time-frequency resource allocation for the apparatus to transmit the information; which one or more channel properties are to be reported as part of the information; or one or more ALs to be used for a subsequent downlink control channel transmission.

In some embodiments, the method may include transmitting a paging message during the paging operation. In some embodiments, the paging message may include apparatus-specific information indicating whether or not the apparatus has been paged. In some embodiments, the paging message may additionally include at least one of the following that is common for a plurality of apparatuses: a time-frequency resource allocation to be used for transmitting the information; an indication of which one or more channel properties are to be reported as part of the information; an indication of one or more ALs to be used for a subsequent downlink control channel transmission; sensing information related to a sensing operation; quasi co-location (QCL) reference signal information; or an indication of timing adjustment (TA) for an uplink transmission.

In some embodiments, the method may include transmitting a LP-WUS or a reference signal that at least one of: triggers the apparatus to switch to a different transceiver; indicates a location of time-frequency resources in a downlink control channel used by the device to transmit a paging notification; or indicates one or more ALs for the downlink control channel used by the device to transmit the paging notification.

In some embodiments, a device (e.g. network device, such as a TRP) is provided to perform any of the methods. For example, the device may include at least one processor and a memory storing processor-executable instructions that, when executed by the at least one processor, cause the device to perform any of the methods. For example, the processor-executable instructions, when executed by the at least one processor, may cause the device to: transmit a downlink signal during a paging operation; and receive information from an apparatus, the information based on at least one channel property that was measured by the apparatus using the downlink signal. In some embodiments, the device is a chip, e.g. an integrated circuit (IC) chip. In some embodiments, the device does not execute instructions by a processor to perform the methods, e.g. the device may comprise circuitry such as a field-programmable gate array (FPGA), a graphical processing unit (GPU), or an application-specific integrated circuit (ASIC), that performs the methods. More generally, the device may comprise modules or units to perform the methods, e.g. a unit or module to transmit a downlink signal during a paging operation, and a unit or module to receive the information from the apparatus. In some embodiments, the device may include means for performing the method steps, e.g. the device may comprise a means to transmit a downlink signal during a paging operation, and a means to receive the information from the apparatus.

According to an aspect of the present disclosure, there is provided a device. The device includes a communication unit configured to transmit a downlink signal during a paging operation and receive information from an apparatus, the information based on at least one channel property that was measured by the apparatus using the downlink signal.

Finally, in an aspect there is provided a computer-readable medium having stored thereon computer-readable instructions that, when executed, cause any of the methods described herein to be performed. The computer readable medium may be non-transitory. In another aspect, there is provided a computer program product having the instructions stored thereon for performing any of the methods described herein. In another aspect, there if provided a device configured to perform any of the methods described herein. In another aspect, there is provided processor configured to execute instructions to cause a device to perform any of the methods described herein. In another aspect, there is provided an integrated circuit configured to perform any of the methods described herein.

### BRIEF DESCRIPTION OF THE DRAWINGS

Embodiments will be described, by way of example only, with reference to the accompanying figures wherein:

FIG. 1 is a network diagram of an example communication system;

FIG. 2 is a block diagram of an example electronic device;

FIG. 3 is a block diagram of another example electronic device;

FIG. 4 is a block diagram of example component modules;

FIG. 5 illustrates three UEs communicating with a TRP in a communication system, according to some embodiments;

FIG. 6 illustrates a paging operation, according to some embodiments;

FIG. 7 illustrates an example of a UE having both a low-power and main receiver;

FIG. 8 illustrates a paging operation when the UE implements both a main receiver and a wake-up receiver, according to some embodiments;

FIG. 9 illustrates a method performed by the UE and TRP, according to some embodiments;

FIG. 10 illustrates an example of FIG. 9 in which the downlink signal is a synchronization signal;

FIG. 11 illustrates the transmission of multiple downlink beams, according to some embodiments;

FIG. 12 illustrates a modification of FIG. 9 including an additional initial step relating to configuration;

FIG. 13 illustrates an example of FIG. 12 in relation to two UEs; and

FIGS. 14 and 15 illustrate two examples of FIG. 10.

### DETAILED DESCRIPTION OF THE ILLUSTRATIVE EMBODIMENTS

For illustrative purposes, specific example embodiments will now be explained in greater detail below in conjunction with the figures.

The methods described herein are implemented in a communication system that implements wireless communication. Therefore, an example communication system that includes wireless communication is first described below.

### Example Communication Systems and Devices

This application may be applied to sixth generation (6G) or future generation communications system. An exemplary communication system (that may be a 6G communication system) is illustrated below.

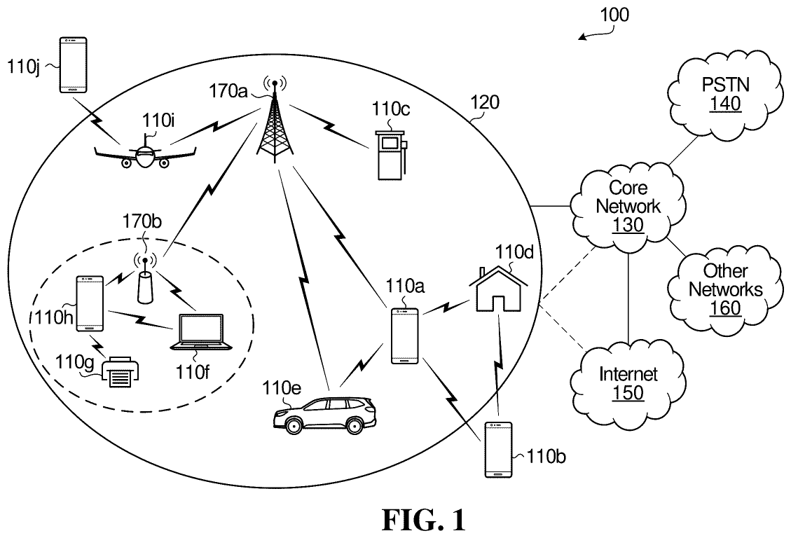

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160. A base station or TRP is an example of 170 and a UE is an example of 110.

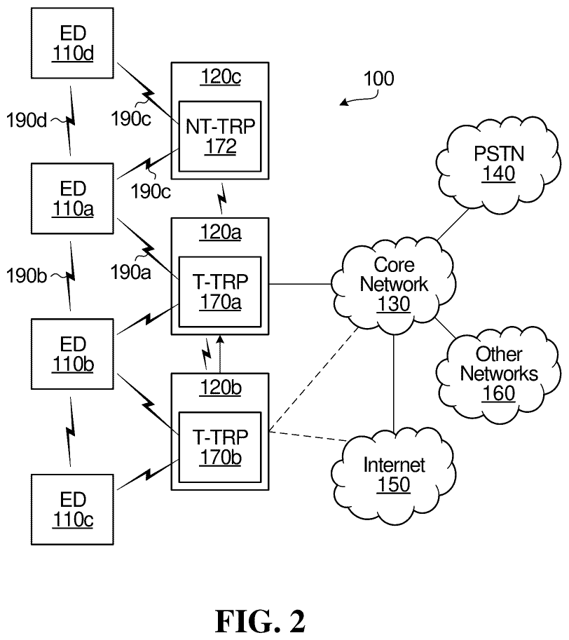

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

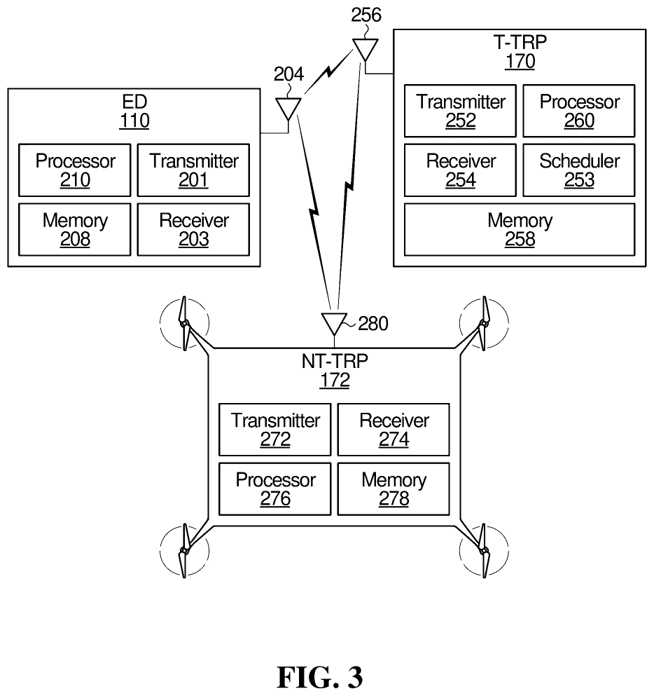

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation Eds 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

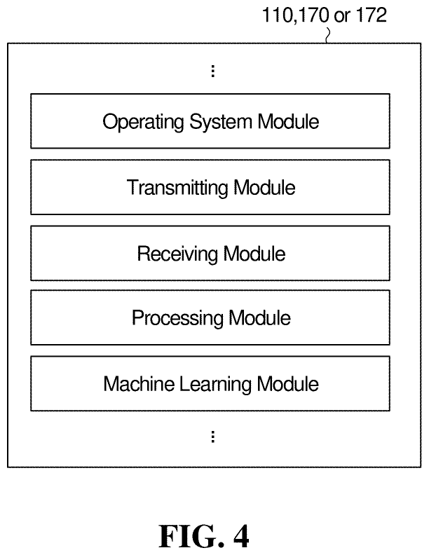

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some implementations, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some implementations, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case, the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Implementations of flexible frame structures include different parameters that may be configurable, e.g. frame length, subframe length, symbol block length, etc. A non-exhaustive list of possible configurable parameters in some implementations of a flexible frame structure include:
(1) Frame: The frame length need not be limited to 10 ms, and the frame length may be configurable and change over time. In some implementations, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some implementations, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one implementation, the slot configuration is common to all UEs or a group of UEs. For this case, the slot configuration information may be transmitted to UEs in a broadcast channel or common control channel(s). In other implementations, the slot configuration may be UE specific, in which case the slot configuration information may be transmitted in a UE-specific control channel. In some implementations, the slot configuration signaling can be transmitted together with frame configuration signaling and/or subframe configuration signaling. In other implementations, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some implementations the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some implementations, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some implementations, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some implementations, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other implementations, a BWP may have one or more carriers, e.g. a BWP may have a bandwidth of 40 MHz and consists of two adjacent contiguous carriers, where each carrier has a bandwidth of 20 MHz. In some implementations, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some implementations, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

Control information is sometimes referenced herein. Control information may sometimes instead be referred to as control signaling or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH, downlink control information (DCI) sent in a PDCCH, or sidelink control information (SCI) sent in a physical sidelink control channel (PSCCH). A dynamic indication may be an indication in lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling such as RRC signaling and/or a MAC CE. Dynamic signaling, as used herein, may refer to signaling that is dynamic, e.g. physical layer control signaling sent in the physical layer, such as DCI sent in a PDCCH, UCI sent in a PUCCH, or SCI sent in a PSCCH.

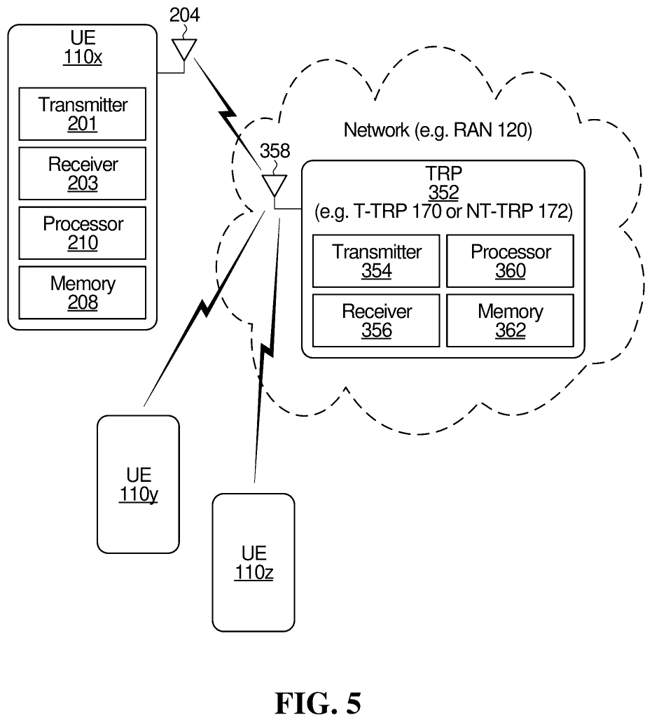

FIG. 5 illustrates three EDs communicating with a TRP 352 in a communication system, according to some embodiments. The communication system may be communication system 100 described above. The three EDs are each illustrated as a respective different UE, and will be referred to as UEs 110x, 110y, and 110z. However, the EDs do not necessarily need to be UEs. In the following, the reference character 110 will be used when referring to any one of the UEs 110x, 110y, 110z, or any other UE (e.g. the UEs 110a-j introduced earlier).

The TRP 352 may be T-TRP 170 or NT-TRP 172. In some embodiments, the parts of the TRP 352 may be distributed. For example, some of the modules of the TRP 352 may be located remote from the equipment housing the antennas or panels of the TRP 352, and may be coupled to the equipment housing the antennas or panels over a communication link (not shown). Therefore, in some embodiments, the term TRP 352 may also refer to modules on the network side that perform processing operations, such as resource allocation (scheduling), message generation, encoding/decoding, etc., and that are not necessarily part of the equipment housing the antennas and/or panels of the TRP 352. For example, the modules that are not necessarily part of the equipment housing the antennas/panels of the TRP 352 may include one or more modules that generate the downlink signal, paging notification, and paging message described herein. The modules may also be coupled to other TRPs. In some embodiments, the TRP 352 may actually be a plurality of TRPs that are operating together to serve UEs 110, e.g. through coordinated multipoint transmissions.

The TRP 352 includes a transmitter 354 and receiver 356, which may be integrated as a transceiver. The transmitter 354 and receiver 356 are coupled to one or more antennas 358. Only one antenna 358 is illustrated. One, some, or all of the antennas may alternatively be panels. The processor 360 of the TRP 352 performs (or controls the TRP 352 to perform) the operations described herein as being performed by the TRP 352, e.g. generating and transmitting the downlink signal, paging notification, and paging message. Generation of messages for downlink transmission may include arranging the information in a message format, encoding the message, modulating, performing beamforming (as necessary), etc. Processing uplink transmissions (such as the information from the UE relating to the measurement of a channel property) may include performing beamforming (as necessary), demodulating and decoding the received messages, etc. Although not illustrated, the processor 360 may form part of the transmitter 354 and/or receiver 356. The TRP 352 further includes a memory 362 for storing information.

The processor 360 and processing components of the transmitter 354 and receiver 356 may be implemented by the same or different one or more processors that are configured to execute instructions stored in a memory (e.g. in memory 362). Alternatively, some or all of the processor 360 and/or processing components of the transmitter 354 and/or receiver 356 may be implemented using dedicated circuitry, such as a programmed FPGA, a GPU, or an ASIC.

If the TRP 352 is T-TRP 170, then the transmitter 354 may be or include transmitter 252, the receiver 356 may be or include receiver 254, the processor 360 may be or include processor 260 and may implement scheduler 253, and the memory 362 may be or include memory 258. If the TRP 352 is NT-TRP 172, then the transmitter 354 may be or include transmitter 272, the receiver 356 may be or include receiver 274, the processor 360 may be or include processor 276, and the memory 362 may be or include memory 278.

Each UE 110 (e.g. each of UEs 110x, 110y, and 110z) includes a respective processor 210, memory 208, transmitter 201, receiver 203, and one or more antennas 204 (or alternatively panels), as described earlier. Only the processor 210, memory 208, transmitter 201, receiver 203, and antenna 204 for UE 110x is illustrated for simplicity, but the other UEs 110y and 110z also include the same respective components.

The processor 210 performs (or controls the UE 110 to perform) the operations described herein as being performed by the UE 110, e.g. cycling between sleep and wake-up, performing a paging operation, measuring a channel property using a downlink signal, etc. The processor 210 generates messages for uplink transmission and processes received downlink transmissions. Generation of messages for uplink transmission may include arranging the information in a message format, encoding the message, modulating, performing beamforming (as necessary), etc. Processing received downlink transmissions may include performing beamforming (as necessary), demodulating and decoding the received messages, etc. Although not illustrated, the processor 210 may form part of the transmitter 201 and/or receiver 203.

Power savings is a criterion that may be taken into consideration in a wireless network, e.g. it may be a performance metric. In one example of power savings, the UE 110 and/or the TRP 352 may operate according to discontinuous reception (DRX) and/or discontinuous transmission (DTX), where the UE 110 or TRP 352 may be in a lower-power sleep mode much of the time and wake up periodically to receive or transmit information on demand. Paging is one function that may help with power savings and that may be associated with a DRX or DTX. For example, a group of UEs in a sleep mode may wake up to receive a paging message in a paging occasion (among configured periodic occasions). In one example, the UEs 110x to 110z form a paging group or subgroup. “Group”, as used herein, also encompasses a subgroup. The group of UEs are configured to have sleep periods during which each UE 110 is in a lower-power sleep mode, as well as wake-up periods, e.g. based on a DRX cycle. During a wake-up period, each UE 110 in the group is configured to wake up from the sleep mode and perform a paging operation that involves performing downlink timing synchronization, monitoring for and detecting/decoding a paging notification that schedules a paging message, and receiving and decoding the paging message. The paging message indicates which UEs have been paged. The network pages a UE in the paging message when the network has data to transmit to that UE.

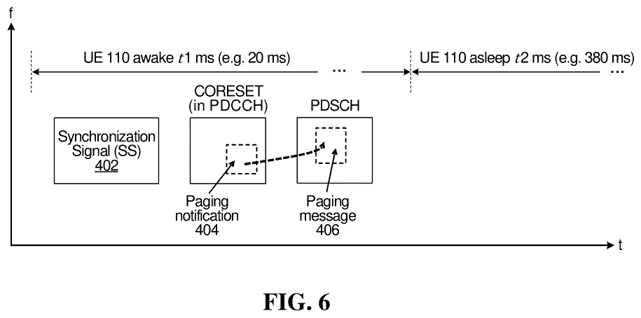

FIG. 6 illustrates a paging operation for each UE 110 of the paging group, according to some embodiments. The UE 110 cycles between a sleep mode during a sleep period and a wake-up mode during a wake-up period, e.g. according to a DRX cycle. In the sleep mode the UE may, for example, have no activity for transmission and reception and/or the UE may try to have minimum power usage for a transceiver background operation or even turn off its transceiver.

The UE 110 wakes from a sleep mode and enters a wake-up period in which the UE 110 is awake for a period of time, e.g. 20 ms. During the wake-up period, the UE 110 begins the paging operation, including first performing downlink synchronization using a synchronization signal (SS) 402. The SS 402 may be located at a predefined time-frequency location and it may be a predefined sequence. The way in which the UE 110 synchronizes using the SS 402 is implementation specific. However, in one example the UE 110 may perform correlation between the received SS 402 and the predefined sequence at different points in time and find the strongest correlation, which corresponds to the timing to which the UE synchronizes. The SS 402 may, for example, be in a synchronization signal block (SSB). For example, the SS 402 may be a primary synchronization signal (PSS) and/or a secondary synchronization signal (SSS) in an SSB. However, more generally, the SS 402 need not necessarily be in an SSB, nor does it have to be a PSS or SSS. In some implementations, the SS 402 might instead be, for example, a reference signal or a low-power synchronization signal (LP-SS), either of which might or might not be dedicated for synchronization for the purposes of performing paging.

After downlink timing synchronization, the UE monitors for and detects a paging notification 404 in a control channel, e.g. in a DCI. In one example, the paging notification 404 is carried by a common PDCCH. In some embodiments, the paging notification 404 may alternatively be called a paging DCI or a paging-group based DCI. In some embodiments, due to a plurality of PDCCH candidates with one or more aggregation levels (ALs) defined/configured within a control resource set (CORESET), the UE 110 may need to perform blind detection on a PDCCH among the plurality of PDCCH candidates. In some embodiments, the UE 110 is configured to monitor for the paging notification 404 during a configured paging occasion. There may be more than one paging occasion during a wake-up period.

The paging notification 404 schedules a paging message 406 in a data channel, e.g. in a PDSCH. For example, the paging notification 404 indicates the time-frequency location of the paging message 406 in the data channel. The paging message 406 indicates which UEs in the paging group have been paged. For example, it might be the case that UE 110x is paged, but UE 110y and 110z are not paged. If a UE 110 is paged, it may perform further operations, e.g. transceiver type switching and/or a random access procedure and/or radio resource control (RRC) state transition for downlink traffic reception or starting an uplink transmission, etc.

In some embodiments, the paging notification 404 might be transmitted in a particular slot (e.g. in an area of the first few symbols of the slot), and the time-frequency resource location of the paging message 406 (that is indicated in the paging notification 404) is one or more subsequent slots away.

In some embodiments, a paging occasion is configured for the UE 110. The paging occasion may be the period of time during which the UE 110 is to receive the paging notification 404 and the paging message 406. In other embodiments, the paging occasion may be the period of time during which the UE 110 is to receive the paging notification 404, but the paging message 406 may be scheduled at a later time that is not necessarily considered part of the paging occasion. More than one paging occasion might be configured during a wake-up period.

Note that in the example of FIG. 6 and in other places herein, it is assumed that there is both a paging notification 404 and a paging message 406, where the paging notification 404 schedules the paging message 406. However, in some embodiments it could instead be the case that there is only a paging notification 404, e.g. DCI that indicates that one or more UEs are paged. In this situation, the paging notification 404 might alternatively be called a paging message. Also, in some embodiments, the paging notification 404 may be more generally called a downlink notification, e.g. because it may notify things other than just paging, or a notification message.

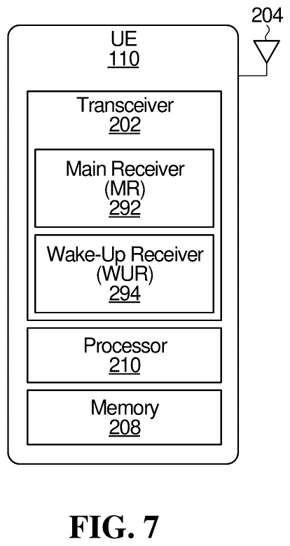

In some embodiments, the UE 110 may have a low-power wake-up receiver (LP-WUR) and switch to a main receiver, e.g. in response to a trigger from the TRP 352. FIG. 7 illustrates an example in which UE 110 has both a low-power and main receiver. In the illustrated example, the UE 110 has a transceiver 202 for sending and receiving wireless transmissions. The transceiver 202 includes a “normal”/legacy or main receiver (MR, or alternatively called main radio) 292 that consumes more power than the LP-WUR and is the main receiver used for receiving wireless communications. The transceiver 202 also includes a LP-WUR referred to as wake-up receiver (WUR) 294. Note that WUR and LP-WUR are terms that are used inter-changeably herein. The WUR 294 consumes less power than the MR 292 and may be lower cost than the MR 292. The WUR 294 may be used, for example, for synchronizing, and possibly for some of the paging operations. The operations performed by the WUR 294 may be referred to as wake-up reception. In a variation of FIG. 7, there may instead be two separate transceivers: a low-cost/low-power transceiver implementing WUR 294, and a legacy or normal transceiver implementing MR 292. Switching from the WUR 294 to the MR 292 may require switching from the low-cost/low-power transceiver to the legacy/normal transceiver.

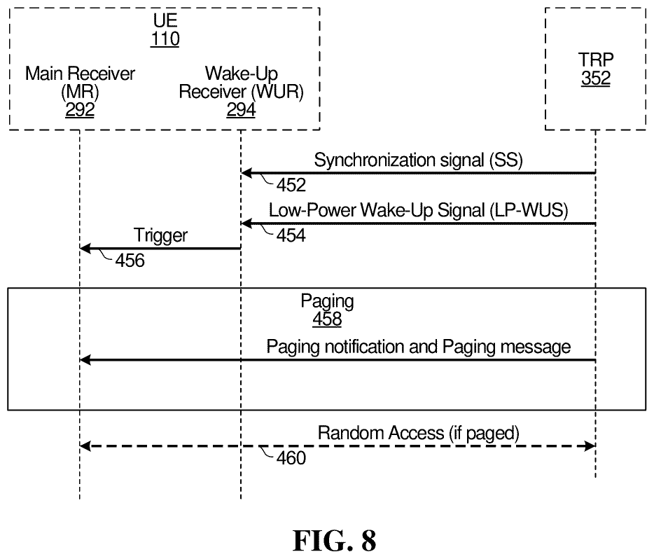

FIG. 8 illustrates a paging operation when a UE 110 implements both a MR 292 and a WUR 294, according to some embodiments. At step 452 the TRP 352 transmits a synchronization signal (SS), which is received by the WUR 294 during a wake-up period. The SS is used by the UE 110 to perform synchronization. At step 454, the TRP 352 transmits a low-power wake-up signal (LP-WUS) that triggers the UE 110 to switch from the WUR 294 to the MR 292, as shown at 456. In this example, the MR 292 is used to perform the subsequent paging operations. At step 458, paging occurs, including the UE 110 receiving a paging notification that schedules a paging message. If the UE 110 is paged in the paging message, the UE 110 may perform random access, e.g. as shown at step 460.

In some embodiments, the TRP 352 may also have a low-power transceiver and a main (“normal”) or legacy transceiver. The low-power transceiver may, for example, be used by the TRP 352 to transmit the LP-WUS. In some embodiments, the TRP 352 may use the main transceiver for one or more paging operations, e.g. for transmitting an SS (e.g. in an SSB) etc. In other embodiments, the TRP 352 may use the low-power transceiver for one or more paging operations, e.g. for transmitting a low-power SS (LP-SS). In one example, the TRP 352 uses its low-power transceiver to perform steps 452 and 454 of FIG. 8 (where the SS in step 452 is a LP-SS), and the TRP 352 switches to the main receiver for paging 458. Similarly, in this example the UE 110 uses its WUR 294 for steps 452 and 454 and then switches to its MR 292 for paging 458.

In some embodiments, the LP-WUS may be a simplified paging notification that is sent to the UE 110 and received by the WUR 294. Although not illustrated in FIG. 8, in some embodiments the UE 110 may be able to transmit a wake up signal (WUS), which may be an uplink lower power signal. The WUS may be received by a low power transceiver of the TRP 352 or by the main receiver of the TRP 352, depending upon the implementation. In some embodiments, the UE 110 may use the WUR 294 and WUS when the UE 110 is in a power saving mode, and the UE 110 may be triggered to switch to the MR 292. In some embodiments, the UE 110 can be triggered to switch back from the MR 292 to the WUR 294. In some embodiments, the triggering or switching between a MR 292 and a WUR 294 may be indicated by the TRP 352 (e.g., in DCI) or based on certain conditions such as traffic loading, application types that are configured by network (e.g., in RRC), etc.

In some embodiments, when the TRP 352 is operating using a low-power transceiver and transmits a LP-SS as the SS 456, the LP-SS may be received by the WUR 294 of the UE 110, as illustrated, or it might in other embodiments be received by the MR 292 of the UE 110.

As mentioned earlier, when performing the paging operation, the UE 110 has an opportunity to measure one or more properties of the wireless channel. In some instances, it might be the case that some sort of measurement is performed by the UE 110 as part of implementing one or more steps of the paging operation, e.g. when the UE 110 performs synchronization. However, that measurement is not necessarily a channel property, and in any case, it is not reported to the TRP 352 in any circumstances, whether or not the UE is being paged. More generally, the UE 110 has the opportunity during a paging operation to measure one or more channel properties that are not needed to implement the paging operation and are not currently measured during the paging operation. For example, when receiving the SS 402 to perform synchronization prior to monitoring for the paging notification 404, the UE 110 can measure the signal-to-noise ratio (SNR) of the synchronization signal 402 to obtain an indication of channel quality, even though this is not needed to synchronize and subsequently receive the paging notification 404 and paging message 406. Since the UE 110 is already receiving the SS 402, the UE 110 can readily measure and derive the channel conditions from that signal.

Configuring the UE 110 to measure one or more channel properties, such as SNR, during a paging operation and reporting the measurement to the TRP 352 may provide useful information to the network. The network may use such information to, for example, better optimize scheduling and/or help in mitigating or avoiding interference and/or better control communication and/or better control sensing, etc.

In some embodiments herein, the UE 110 performs the measurement of one or more channel properties during the paging operation and reports it, even if the UE 110 is not paged. The result may be avoiding information wastage (e.g. by reporting instead of discarding valuable information) and more efficiently providing the information because it piggybacks off of a downlink signal already transmitted for the purposes of paging, rather than the network configuring a separate occasion (different from paging) during which a dedicated downlink signal must be sent to the UE 110 for measuring and reporting. In some embodiments, configuration and signaling procedures are disclosed to provide measurement information from UEs in a paging group, where the measurement information is obtained via measuring a downlink signal transmitted from the network during a paging operation. In one example, the downlink signal may be a broadcast or cell-common synchronization or reference signal, which may be sent before a paging notification. In another example, the downlink signal may be a demodulation reference signal (DMRS).

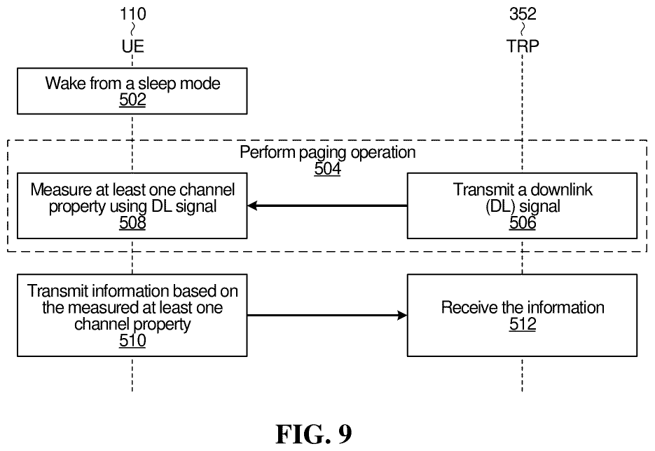

FIG. 9 illustrates a method performed by UE 110 and TRP 352, according to some embodiments. At step 502, the UE 110 wakes from a sleep mode to perform a paging operation. At step 504, the UE 110 performs the paging operation, e.g. synchronizes and receives a paging notification and/or paging message. During the paging operation, the TRP 352 transmits a downlink signal, as shown at step 506. At step 508, the UE 110 measures at least one channel property using the downlink signal. The channel property measured is a property of the downlink channel over which the downlink signal was sent. In some embodiments, the channel property may alternatively be called a “channel metric” or just “metric”. At step 510, the UE 110 transmits information based on the measured at least one channel property. At step 512, the TRP 352 receives the information. Steps 510 and 512 are illustrated as occurring after the paging operation 504. However, they may instead occur as part of the paging operation 504.

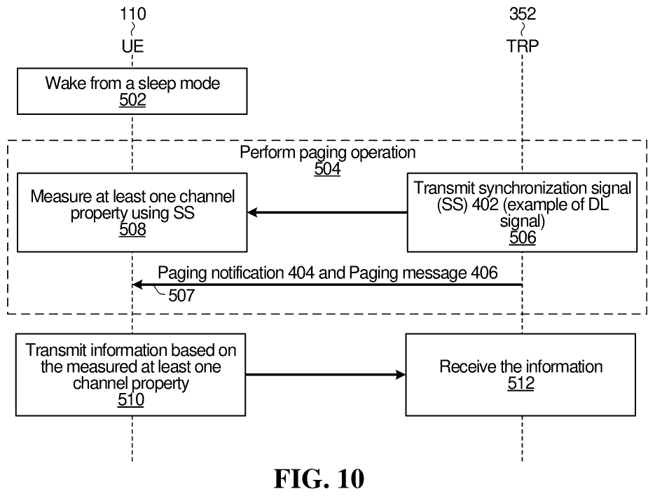

FIG. 10 illustrates one example of the method of FIG. 9 in which the downlink signal transmitted by the TRP 352 at step 506 is the synchronization signal (SS) 402 used by the UE 110 to perform synchronization prior to monitoring for the paging notification 404. The UE 110 uses the SS 402 to not only perform downlink timing synchronization, but to also measure at least one channel property (e.g. SNR) of the downlink channel on which the SS 402 was sent. Subsequent paging operations include the TRP 352 transmitting and the UE 110 receiving the paging notification 402 and the paging message 404.

In some embodiments of the method of FIG. 9, the measuring of the at least one channel property performed in step 508 may include measuring at least one of the following using the downlink signal: reference signal received power (RSRP); reference signal received quality (RSRQ); signal-to-noise ratio (SNR); signal-to-interference-and-noise ratio (SINR); channel quality; Doppler shift; Doppler spread; average delay; delay spread; or other channel characteristics.

One or more of the preceding channel properties may be or represent typical and important parameters used to measure the quality of a cellular network signal and channel. For example, RSRP measures the average power received from a reference signal (where the “reference signal” here refers to the downlink signal measured in step 508, even if that downlink signal is not literally called a “reference signal”). In one example, the typical range of RSRP may be around −44 dbm (good) to −140 dbm (bad). As another example, RSRQ measures the quality of the received signal (where again the “reference signal” here refers to the downlink signal measured in step 508, even if that downlink signal is not literally called a “reference signal”). In one example, the typical range of RSRQ is, for example, −19.5 dB (bad) to −3 dB (good). SINR represents a signal-to-noise ratio of the downlink signal, which is also a measure of signal quality. Channel quality indicator (CQI) can be another metric of channel quality measurement that may be used to optimize the usage of, e.g., modulation and coding schemes. These properties may provide a big picture of one or more UEs on its/their geographic information and/or channel conditions/quality. In some embodiments, the measurement performed in step 508 may measure the state of the channel. In some embodiments, the result of the measurement may be referred to as the channel state information (CSI).

In some embodiments of the method of FIG. 9, the UE 110 may receive configuration information that configures which one or more channel properties the UE 110 is to measure at step 508. For example, prior to measuring the at least one channel property in FIG. 9, the UE 110 may receive a message (e.g. transmitted by the TRP 352). The message may configure the at least one channel property to be measured at step 508. In some embodiments, the message may be received by the UE 110 in at least one of: radio resource control (RRC) signaling; a medium access control (MAC) control element (MAC-CE); a synchronization signal block (SSB) (e.g. the same SSB that carries the SS 402); system information (SI); a downlink control information (DCI) (e.g. DCI in the PDCCH that carries the paging notification 404); a low-power wakeup signal (LP-WUS) (e.g. the LP-WUS transmitted in step 454 of FIG. 8); or a paging notification (e.g. paging notification 404). In some embodiments, the message configuring the at least one channel property to be measured may be received semi-statically or dynamically, or a combination of both semi-static and dynamic (in which case the message may be distributed over multiple messages), e.g. RRC signaling or MAC-CE to configure of a set of channel properties to possibly measure and DCI to dynamically indicate of which one or ones should be measured for a given paging operation. In some embodiments, the message configuring the at least one channel property may be received when the UE 110 is in an Inactive or Idle state (e.g. where the UE 110 may stay silent or in a sleep mode) or in an Active or Connected state (e.g. where the UE 110 may communicate traffic actively with the network). In some embodiments, the message configuring the at least one channel property may configure related information, such as metric threshold values relating to when the channel property should be reported. For example, the message may indicate that if a certain channel property is below a certain measured threshold (e.g. very low signal strength), then the channel property need not be reported. In some embodiments, the message configuring the at least one channel property to be measured may also configure other information. For example, it may also configure information related paging, e.g. it may configure one or more wake-up periods, sleep periods, paging occasions, etc.

In some embodiments of the method of FIG. 9, the downlink signal transmitted by the TRP 352 and used to measure the at least one channel property may be a synchronization signal (SS), e.g. like in the example of FIG. 10. If the downlink signal is a SS, then the UE 110 may use the SS to both measure the at least one channel property and perform synchronization. The synchronization may occur prior to the UE 110 receiving the paging notification 404. In some embodiments, the SS may be in an SSB, e.g. the SS may be a PSS and/or an SSS. In other embodiments, the SS is not in an SSB. For example, the SS may be an SS dedicated for use in synchronizing for the purposes of performing paging. In some embodiments, the SS may be a low power synchronization signal (LP-SS). In some embodiments, the SS may be a reference signal, e.g. a paging reference signal. In some embodiments, the LP-SS or SSB (or SS in an SSB) may be referred to as a reference signal.

In some embodiments of the method of FIG. 9, the downlink signal might not be an SS, but might instead be another downlink signal transmitted during the paging operation that is not even necessarily used for synchronization. For example, in some embodiments, the downlink signal may be or include a demodulation reference signal (DMRS) or other downlink reference signal. A DMRS may be transmitted from the TRP 352 at one or more points during the paging operation. The DMRS may be used by the UE 110 for performing channel estimation. In performing the channel estimation, a channel property may be measured, e.g. the UE 110 may have estimated knowledge of the channel conditions or quality. Alternatively, although the UE 110 uses the DMRS for channel estimation, it might not normally be used for measuring certain channel properties such as SNR. However, the DMRS can additionally be used to measure these one or more channel properties of interest at step 508. The channel property measured corresponds to the downlink channel on which the DMRS was transmitted. In one example, the DMRS is in a data channel that also carries the paging message 406, e.g. the DMRS is used for estimating the PDSCH carrying the paging message 406, and the DMRS is also used for measuring the at least one channel property. In another example, the DMRS is in a control channel that also carries the paging notification 404, e.g. the DMRS is used for estimating the PDCCH carrying the paging notification 404, and the DMRS is also used for measuring the at least one channel property. In another example, the DMRS is in an SSB. The SSB may be used to perform synchronization and may carry system information bits. The DMRS in the SSB may be used for channel estimation and may also be used to measure at least one channel property.

In some embodiments of the method of FIG. 9, the UE 110 may additionally be configured to perform sensing. Sensing may include the UE 110 performing a sensing operation using a received sensing signal (which may alternatively be called a sensing reference signal). The sensing signal may be a downlink signal that is transmitted by the TRP 352 and that is to be used by the UE 110 for sensing purposes. For example, the UE 110 may measure the signal strength, direction, angle of arrival, etc. of the sensing signal. In some embodiments, the sensing signal may be a single tone signal. In some embodiments, the sensing signal may be a RADAR signal. In some embodiments, “communication” as used herein may refer to “normal” traffic transmission and reception of control messages and/or data messages, while sensing may refer to channel sounding or estimation to obtain UE/object geographic information or channel conditions/quality. By the UE 110 measuring the sensing signal and reporting to the TRP 352, the TRP 352 may, for example, be able to infer the physical environment around the UE 110. Multiple UEs involved in sensing may form a sensing group or a group sensing, and the group sensing may make use of the paging procedure for measurement and reporting, thus possibly being able to save power for sensing in a power saving mode such as Inactive, Idle state, etc.

In embodiments in which a sensing signal is received when the UE 110 is awake to perform the paging operation, that sensing signal may be the downlink signal referred to in FIG. 9 and it may be used by the UE 110 to measure the at least one channel property in step 508. The measurement performed in step 508 might be a measurement performed as part of sensing, or it might instead be measuring a channel property not normally measured as part of sensing. In some embodiments, sensing and/or communication may be configured (e.g. indicated) when the UE 110 is configured (e.g. indicated) to perform the measurement and/or reporting. In some embodiments, the paging message may include bits to indicate incoming sensing or/and communication operation. In some embodiments, a LP-WUS, DCI, or even an SSB can be used to indicate sensing and/or communication operation. The downlink signal measured in step 508 may be a sensing reference signal or a communication reference signal (or both, e.g. if these two reference signals have a QCL relationship). In some embodiments, the measurement and reporting may complement, be part of, or be in addition to sensing reporting, and may help sensing operations or enhance an integrated sensing and communication. In some embodiments, a UE involved in a sensing UE group may be configured or notified to measure the sensing or communication reference signals and report the measurement metrics in or for configured paging occasion(s) when the UE is in a power saving mode (e.g., Inactive or Idle state) and with a paging group. As a result, one or more UEs in a paging group configured or indicated for the channel measurement and reporting may be of significance to help sensing operations or enhance an integrated sensing and communication.

In some embodiments of the method of FIG. 9, the information transmitted in step 510 that is based on the at least one measured channel property may be an explicit or implicit indication of the value of the at least one measured channel property. For example, if the UE 110 measures the SNR of the downlink signal, the information transmitted at step 510 may directly indicate the SNR that was measured. In some embodiments, the information transmitted at step 510 may be a report that was derived from the measured at least one channel property. The report may alternatively be referred to as a measurement report or a CSI report, or even just the CSI. The report may explicitly or implicitly indicate the value of the at least one measured channel property, e.g. if SNR was measured then the report may indicate the value of the SNR. The report may also or instead indicate information that is based on the at least one measured channel property. For example, the report may indicate a channel quality index (CQI) value obtained based on the at least one measured channel property. As another example, the report may provide an indication of one or more aggregation levels (ALs). For example, the measured signal strength (e.g. SNR) of the channel may map to particular ALs, e.g. if the channel has a high SNR then the lower ALs (e.g. ALs 1 and 2) may be reported to the TRP 352. The TRP 352 may then use these ALs for subsequent downlink control channel communications. The AL indication may optionally use reference signals with multiple sequences, each mapping to one aggregation level from, e.g., AL1, AL2, AL4, AL8, AL16, etc. For example, a first reference signal sequence may be transmitted by the UE 110 to indicate AL1, a different second reference signal sequence may be transmitted by the UE 110 to indicate AL2, etc.

In the method of FIG. 9, the information transmitted at step 510 can be transmitted at different points in time depending upon the implementation, e.g. during or after a paging operation or paging occasion. In some embodiments, step 510 occurs in the same wake-up period as the paging operation of step 504 (in which the channel property was measured), but step 510 does not necessarily have to occur during the paging operation or paging occasion. For example, step 510 may occur after the paging message 406 is received and decoded. If the UE 110 is not paged, such that the UE 110 is to go back to sleep, the UE 110 may perform step 510 before the UE 110 goes back to sleep. Even if the UE 110 is paged, step 510 may still be performed during the wake-up period, e.g. before transitioning to a connected state. Therefore, in some embodiments, the paging operation 504 is associated with a paging occasion during a wake-up period, and the information transmitted in step 510 is transmitted during that wake-up period, possibly (but not necessarily) during the paging occasion. In another example, step 510 might occur after the UE 110 is back in the sleep mode, e.g. if the UE 110 is configured in the sleep mode to perform grant-free uplink transmissions. In some embodiments, step 510 may occur when the UE 110 is in a power-saving mode, which might or might not be a sleep mode.

In some embodiments, the information transmitted in step 510 may be sent during a random access procedure, sometimes referred to as a random access channel (RACH) procedure. The random access may be implemented in different ways, e.g. a four-step RACH or two-step RACH, depending on the UE 110 capability. For example, a four-step RACH may include: transmission of a preamble (RACH preamble) (“msg1”) by UE 110; receipt of a random access response (RAR) (“msg2”) from TRP 352; transmission of information, such as an RRC connection request (“msg3”) by UE 110; and a response to msg3 (“msg4”), e.g. connection confirmation information, from TRP 352. The information transmitted in step 510 may be transmitted along with or as part of msg1 or msg3. As another example, a two-step RACH may include transmission of msg1 and msg3 (referred to as “msgA”) by UE 110 and receipt of msg2 and msg4 (referred to as “msgB”) from TRP 352. The information transmitted in step 510 may be transmitted along with or as part of msgA. In some embodiments, a random access procedure may be used to transmit the information in step 510 if, for example, the UE 110 does not have a PUCCH configured to send the information and/or if the UE 110 is already performing a random access procedure, e.g. because the UE 110 has been paged.

In some embodiments, the information transmitted in step 510 may be sent in an uplink control channel, e.g. a PUCCH. In other embodiments, the information transmitted in step 510 may be sent in an uplink data channel, e.g. a PUSCH. For example, the information transmitted in step 510 may be transmitted in the uplink data channel along with (e.g. piggybacked in) an uplink data transmission. In one example, the UE 110 is configured to perform grant-free uplink transmissions, e.g. so that the UE 110 can still perform some uplink transmissions when in sleep or low power mode. The UE 110 may transmit the information in step 510 along with uplink data in a grant-free uplink transmission (e.g. piggybacked on the data transmission), or the grant-free uplink transmission may only carry the information of step 510. In another example, the TRP 352 grants UE 110 an uplink resource in the PUCCH or PUSCH to transmit the information in step 510. For example, the grant may be included along with the paging notification or in the paging message.

In some embodiments, the information transmitted in step 510 may be transmitted without an operational state transition, e.g. step 510 may be performed while the UE 110 is in an RRC Inactive or RRC Idle state. That is, step 510 does not need to require transitioning to an RRC Active state. However, in other embodiments, step 510 might require transitioning to an RRC connected state. More generally, the paging with channel measurement and reporting (and possible sensing operation) may be applicable to both power saving mode, e.g., Inactive state, and a normal power operation mode, e.g., Connected state. Note that in some implementations a Connected state could still have paging activity and sleep modes.

In some embodiments, the information transmitted in step 510 may be sent in or using a wake up signal (WUS). The WUS is described earlier and, as explained earlier, it may be an uplink lower power signal that may be received by a low power transceiver of the TRP 352 or by the main receiver of the TRP 352. In some embodiments, transmitting the information in the WUS might be performed by transmitting a particular one of multiple possible WUS transmission sequences. For example, each transmission sequence may map to a different indication of the channel property and/or channel condition and/or channel quality, e.g. each WUS transmission sequence maps to a different measured signal strength. The UE 110 selects the WUS transmission sequence that best reflects the measured at least one channel property.

In some embodiments, the information transmitted in step 510 may be sent in or using an uplink reference signal, e.g. a sounding reference signal (SRS). In some embodiments, transmitting the information in the uplink reference signal (e.g. SRS) might be performed by transmitting a particular one of multiple possible transmission sequences. For example, each transmission sequence may map to a different indication of the channel property and/or channel condition and/or channel quality, e.g. each SRS sequence maps to a different measured signal strength. The UE 110 selects the SRS sequence that best reflects the measured at least one channel property.

In some embodiments, the information transmitted in step 510 may be sent in uplink time-frequency resources that are indicated by the TRP 352. The uplink time-frequency resources may, for example, be indicated in at least one of: radio resource control (RRC) signaling; a MAC control element (MAC-CE); a SSB (e.g. the same SSB used to carry SS 402); system information (SI); a DCI; a low-power wake up signal (LP-WUS), e.g. the one transmitted in step 454 of FIG. 8; a paging notification (e.g. paging notification 404); or a paging message (e.g. paging message 406). In some embodiments, the uplink time-frequency resources may be semi-statically indicated, or dynamically indicated, or both semi-statically and dynamically indicated, e.g. RRC signaling or MAC-CE to configure uplink time-frequency resources and DCI to dynamically indicate/activate particular ones of those configured uplink time-frequency resources when step 510 is to be performed. In some embodiments, the configured uplink time-frequency resources may be in a control channel (e.g. PUCCH). In other embodiments, the configured uplink time-frequency resources may be in a data channel (e.g. PUSCH).

In some embodiments, no matter how the information is transmitted in step 510 (e.g. whether in a PUCCH or PUSCH, etc.) the information may be transmitted using a low-cost transceiver or using a main/normal transceiver. In some embodiments, whether the information is transmitted using a low-cost transceiver or a normal transceiver may be dependent on when the information is transmitted. For example, if the UE 110 is not paged and step 510 is performed just before the UE 110 goes back to sleep, the UE 110 may perform step 510 using a low-cost transceiver, whereas if the UE 110 has already switched to a main transceiver for other purposes, the UE 110 may also perform step 510 using the main transceiver. In some instances, the UE 110 may be operating using a main transceiver but may switch back to the low-cost transceiver to perform step 510, e.g. if the UE 110 is not paged and is going back to sleep. In other instances, the UE 110 may be operating using a low-cost transceiver and may switch to the main transceiver to perform step 510.

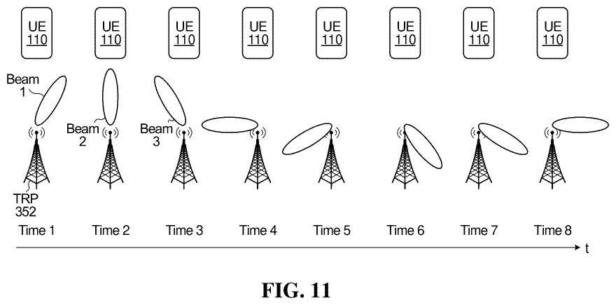

In some embodiments, the TRP 352 may transmit multiple downlink beams, and the method of FIG. 9 may involve per-beam measurements. FIG. 11 illustrates the transmission of multiple downlink beams, according to some embodiments. In the example of FIG. 11, the TRP 352 is implementing a beam sweeping pattern in which a plurality of downlink beams are transmitted, each at a respective different direction and each at a respective different time (e.g. each at a respective different time slot), in order to cover the coverage area of the TRP 352. For example, as illustrated, at time 1 the TRP 352 transmits a first beam (“beam 1”) in a first direction, at time 2 the TRP 352 transmits a second beam (“beam 2”) in a second direction, at time 3 the TRP 352 transmits a third beam (“beam 3”) in a third direction, etc., and this continues until the coverage area of the TRP 352 is covered, which occurs by the end of time 8 in FIG. 11. In some embodiments, an SSB may be transmitted by the TRP 352 in each beam, e.g. so that a UE can synchronize and obtain system information using the SSB in the beam that is strongest (or strong enough) for that UE. For example, for high frequency bands such as millimeter wave frequency band, a paging operation may involve the TRP 352 sending an SSB in different beams, where each beam may cover a specific area. During a paging occasion there may be a link between each SSB transmitted in each beam and a corresponding paging message also transmitted at a later time in that same beam of the beam sweeping pattern, e.g. in a later time slot corresponding to that beam in the pattern.

When there are multiple downlink beams, like in the example in FIG. 11, for each of one or more of those beams the UE 110 may be able to receive a downlink signal on that beam and measure one or more channel properties for that beam. For example, each beam may include an SSB, and the UE 110 may, for a downlink SS in each SSB of one or more beams, measure a channel property of that beam. The UE 110 may experience different signal strengths and/or channel characteristics for different beams. For example, in FIG. 11 “beam 2” is line-of-sight for UE 11 and so the UE 110 may experience a signal strength stronger than the signal on any of the other beams. The UE 110 may, in step 508, report the measured channel property for the strongest beam or beams.

Therefore, in some embodiments, the method of FIG. 9 may operate as follows. The downlink signal transmitted at step 506 and received by the UE 110 may be received on a first beam (e.g. “beam 2” of FIG. 11), and for each beam of one or more other beams the TRP 352 may transmit and the UE 110 may receive a corresponding downlink signal on that beam. For example, the UE 110 may also receive the downlink signal on “beam 1” and “beam 3” of FIG. 11 because those beams are also in the general direction of UE 110, although the received downlink signal might not be as strong as “beam 2” because “beam 2” is line-of-sight. The UE 110 may then implement step 508 of FIG. 9 by measuring the at least one channel property using the downlink signal received on the first beam (e.g. “beam 2” of FIG. 11), and by also measuring the at least one channel property for one or more other beams (e.g. “beam 1” and “beam 3” of FIG. 11) using the corresponding downlink signal received on each of those beams. The information transmitted in step 510 may then be based on the measured at least one channel property for the first beam (e.g. “beam 2” of FIG. 11) and the measured at least one channel property for each of the one or more other beams (e.g. “beam 1” and “beam 3” of FIG. 11). In this way, FIG. 9 may involve performing per-beam measurements during the paging operation and associated reporting. For example, the information transmitted in step 510 may include a CSI report for each beam carrying paging information that the UE 110 measures, or a CSI report that covers a set of such beams. The downlink signal used for the measurement may be any of those discussed earlier, e.g. a beam-based SS (possibly in an SSB), or a beam-based LP-SS, or a beam-based reference signal, or a beam-based DMRS or sensing signal, etc. The property measured may be any of those discussed earlier, e.g. a beam based SNR, RSRP, etc, or something derived from one of those measurements (e.g. a beam-based CQI).

In some embodiments, the information transmitted in step 510 may be or include an indication of one or more beams that have a measured channel property. For example, if the channel property is measured by the UE 110 for beams 1, 2, and 3 of FIG. 11, the UE 110 may indicate those beams in step 510. In some embodiments, the UE 110 may measure or attempt to measure the at least one channel property for each of a plurality of beams, but the UE 110 might only report (in step 510) the beams having the strongest measurement. For example, the UE 110 may be able to measure the channel property for the beams at times 4 and 8 of FIG. 11, but the channel quality is weak because those beams are not close enough to the direction of the UE 110. However, the channel quality is relatively good for beams 1, 2, and 3, and therefore only beams 1, 2, and 3 are reported in step 510.

In some embodiments, the value of the measured at least one channel property is reported in step 510 for each indicated beam. In some embodiments, the UE 110 indicates, in step 510, which beam has the strongest measured channel property (e.g. has the best channel quality). In some embodiments, the UE 110 may be configured to report, in step 510, all the measurements from all beams on a basis of per beam information, whereas in other embodiments the UE 110 may be configured to report the configurable number of strongest beams. In some embodiments, a “strong” or “strongest” beam may be a beam having a measured channel property that is within a particular range, e.g. above or below a particular threshold. In some embodiments, the information transmitted in step 510 may be or include the beam direction and/or beam orientation and/or arrival angle(s) of one or more measured beams (e.g. of the strongest beams). For example, the UE 110 may measure and indicate the direction, orientation, and/or angle of arrival for one or more of the beams and report this as part of step 510, e.g. the UE 110 may report this information in relation to the beams measured by the UE 110 to have the strongest channel quality. In some embodiments, the measured property and/or the indication might also or instead be associated with the location of the UE 110.

In general, by knowing which beam or beams are strongest for the UE 110, the TRP 352 may be able to infer the location of that UE 110, e.g. by inferring that the UE 110 is located in the direction of the beam that has the highest channel quality measured by the UE 110. Thus, the reporting information on the measurement per beam from each UE in the paging group may provide the network with a bigger picture of the UE distribution and channel quality via the sweeping beams from the network or TRP 352.

In some embodiments, if a WUS transmission sequence is transmitted by the UE 110 in step 510 to indicate a channel property (e.g. to indicate channel quality), then there may be a WUS for each beam for which a measurement is being reported, e.g. each WUS having a different sequence if different channel qualities are measured on different beams. The beam direction information and/or beam identity may also be indicated as part of the WUS. In other embodiments, one WUS transmission sequence may indicate and report channel quality measurement for each beam among multiple beams. In some embodiments, if a WUS transmission sequence is transmitted by the UE 110 in step 510 to indicate a channel property (e.g. to indicate channel quality) for a beam, then there may be a WUS transmission sequence for each channel quality level for which a measurement in the beam is being reported, e.g. each WUS having a different sequence if different channel qualities are measured on the beam. The beam direction information and/or beam identity may also be indicated as part of the WUS.

In some embodiments, if the information transmitted in step 510 is a report (e.g. CSI report) that includes an indication of one or more ALs to use for subsequent downlink control channel transmissions, the indication of the ALs may be on a per beam measurement basis. As mentioned above, the measured signal strength (e.g. SNR) of a channel may map to particular ALs, e.g. if the channel has a high SNR then the lower ALs (e.g. ALs 1 and 2) may be reported to the TRP 352. Different beams may have different measured signal strengths (e.g. SNRs), which may map to different ALs. The ALs may be indicated on a beam-by-beam basis. As mentioned above, the AL indication may optionally use reference signals with multiple sequences, each mapping to one aggregation level from, e.g., AL1, AL2, AL4, AL8, AL16, etc. For example, a first reference signal sequence may be transmitted to indicate AL1, a second reference signal sequence may be transmitted to indicate AL2, etc.

In some embodiments of the method of FIG. 9, step 506 may include the TRP 352 transmitting multiple downlink signals, which are received by the UE 110. These multiple downlink signals may have a quasi co-location (QCL) relationship with each other. QCL refers to the relationship between different downlink signals (e.g. different reference signals), which may be in a cell. In some embodiments, QCL relationship may be configured by a higher layer (e.g., RLC) parameter qcl-Type1 for a first downlink signal (e.g. first downlink reference signal) and qcl-Type2 for a second downlink signal (e.g. second downlink reference signal), if configured. In some embodiments, for the case of two downlink reference signals, the QCL types shall not be the same, regardless of whether the references are to the same downlink reference signal or different downlink reference signals. The common QCL types include Type-A (relating to Doppler shift, Doppler spread, average delay, delay spread), Type-B (relating to Doppler shift, Doppler spread, etc.), Type-C (relating to Doppler shift, average delay, etc.), and Type-D (relating to spatial receive parameter, etc.).

If multiple downlink signals are transmitted by the TRP 352 and received by the UE 110, and these multiple downlink signals have a QCL relationship with each other, then step 508 of FIG. 9 of measuring the at least one channel property may be performed by measuring the at least one channel property using at least one of those multiple downlink signals, e.g. using some or all of the multiple downlink signals. The multiple downlink signals might be received on different beams (e.g. one received on beam 1 of FIG. 11 and another received on beam 2 of FIG. 11). Alternatively, the multiple downlink signals might be received on a same beam, e.g. a first downlink signal used for synchronization (e.g. an SS or reference signal) and a second downlink signal used for channel estimation (e.g. a DMRS received in a control or data channel). In another example, the multiple downlink signals may include a sensing specific reference signal and a communication group/cell based downlink signal (e.g. reference signal), such as an SS in an SSB or a LP-SS, assuming the sensing specific reference signal can be configured to be QCLed with the communication group/cell based downlink signal.

By measuring multiple downlink signals having a QCL relationship, it may be possible to measure more accurately the at least one channel property, which may provide for better reporting.

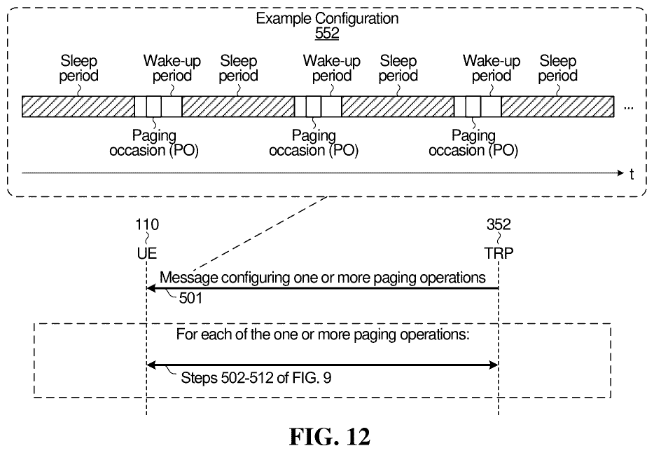

In some embodiments, the paging operation 504 is one of multiple possible paging operations that may be configured for the UE 110. FIG. 12 illustrates a modification of FIG. 9 including an additional initial step 501 in which the TRP 352 transmits and the UE 110 receives a message configuring one or more paging operations. The message in step 501 may configure the one or more paging operations by at least configuring at least one of: one or more wake-up periods; one or more sleep periods; a paging discontinuous reception (DRX) cycle; or one or more paging occasions in a wake-up period. An example of a configuration of paging operations that may be configured by the message is shown in stippled bubble 552. In the example, an alternating cycle of sleep and wake-up periods have been configured for UE 110, e.g. according to a DRX cycle. In each wake-up period, there is a paging occasion configured for the UE 110. More generally, there does not necessarily have to be a paging occasion configured for the UE 110 in each wake-up period (or it might be configured, but dynamic indication may indicate to the UE 110 when the UE 110 can ignore the paging occasion, e.g. if the UE 110 is not being paged). Also, although only one paging occasion is configured in each wake-up period in the example, more generally, there may be multiple paging occasions configured in a same wake-up period. In some embodiments, each configured paging occasion is a duration of time during a wake-up period in which the UE 110 is configured to receive a paging notification (and possibly also a paging message). In some embodiments, each wake-up period may comprise one or more paging occasions for UE 110, but the UE 110 is configured to monitor and detect a paging notification and receive the paging message in only one or some (not necessarily all) of the paging occasions during that wake-up period. In some embodiments, a paging occasion may be a slot in which a paging notification is transmitted, e.g. in an area of a first few symbols of the slot.

After the paging operations are configured via the message in step 501 of FIG. 12, then the steps of FIG. 9 are performed for each of the one or more paging operations.

Note that UE 110 does not necessarily have to be configured to perform steps 508 and/or 510 of FIG. 9 in every configured paging occasion and/or in every configured wake-up period. It might be the case that the measurement and/or reporting only occurs in some of the paging occasions and/or wake-up periods. In general, the times at which the UEs of a paging group are to measure and/or report is configurable, e.g. there is no need to report in every paging occasion, which will save power. In some embodiments, the reporting rate can be at most same as a paging cycle or paging rate, or multiples of paging cycles. Alternatively, any specific paging occasions may be configured or indicated for an aperiodic CSI reporting, e.g. on a dynamic on-demand basis. For example, a DCI may indicate the CSI report on demand, e.g. the DCI may indicate on demand whether the UE 110 is to perform step 510. In some embodiments, the DCI may include a new field or modified field to add one or more bits in a DCI format as the notification to perform the measurement and/or reporting. In some embodiments, the DCI may indicate a PDCCH AL, or it may be part of the paging notification or in a paging message, in order to indicate proper AL(s) or default AL(s) to be used for subsequent downlink PDCCH transmissions.

In some embodiments, the message configuring the paging operations in step 501 of FIG. 12 may be transmitted by the TRP 352 and received by the UE 110 in at least one of: RRC signaling; a MAC-CE; a DCI; an SSB; SI; or, a LP-WUS. In some embodiments, the message may be sent semi-statically or dynamically, or a combination of both semi-static and dynamic (in which case the message may be distributed over multiple messages), e.g. RRC signaling or MAC-CE to configure time-frequency resources for possible paging occasions and DCI to dynamically indicate which instances of those resources are actually paging occasions. In some embodiments, the message configuring the paging operations in step 501 of FIG. 12 may be received when the UE 110 is in an Inactive or Idle state (e.g. where the UE 110 may stay silent or in a sleep mode) or in an Active or Connected state (e.g. where the UE 110 may communicate traffic actively with the network).

In some embodiments, the message configuring the paging operations in step 501 of FIG. 12 (e.g. the message configuring the wake-up periods, sleep periods, and/or paging occasions) may also configure information relating to the channel property measurement and reporting. For example, the message configuring the paging operations may also configure at least one of: one or more wake-up periods during which the UE 110 is to perform step 508 and/or 510 of FIG. 9 (e.g. the UE 110 may be configured to perform the measurement and/or reporting only during some of the wake-up periods); one or more paging occasions for which the UE 110 is to perform step 508 and/or 510 (e.g. the UE 110 may be configured to perform the measurement and/or reporting only in relation to some paging occasions); the at least one channel property that is to be measured; which one or more channel properties are to be reported as part of the information in step 510; a manner in which the information is to be transmitted in step 510 (e.g. whether the information in step 510 is to be transmitted in an uplink control channel or data channel, when step 510 is to be performed, etc.); or uplink time-frequency resources used to transmit the information in step 510. When the message in step 501 of FIG. 12 configures both the paging (e.g. the wake-up periods, sleep periods, and/or paging occasions) and the information relating to the channel property measurement and reporting, then the message might not literally be one message, but may be distributed over multiple decoded bits. In some embodiments, the message configuring the paging operations and/or the measurement and reporting may be a combination of both semi-static and dynamic (in which case the message may be distributed over multiple messages), e.g. RRC signaling or MAC-CE to indicate possible configurations and DCI to dynamically select one of the possible configurations. In some embodiments, the message configuring the paging operations and/or the measurement and reporting may be received when the UE 110 is in an Inactive or Idle state (e.g. where the UE 110 may stay silent or in a sleep mode) or in an Active or Connected state (e.g. where the UE 110 may communicate traffic actively with the network).

In some embodiments, the UE 110 may be configured to only perform step 510 of FIG. 9 in relation to some paging operations (e.g. only in some wake-up periods and/or only in relation to some paging occasions). For example, the UE 110 may perform multiple paging operations among paging DRX cycles, where each of the paging operations may be performed during a respective different wake up period, and where step 510 only occurs for some of the paging operations. A message (e.g. the message of step 501 of FIG. 12) may configure the paging operations for which the UE 110 is to perform step 510.

For instances in which the UE 110 is configured to not report (i.e. to not perform step 510), the UE 110 might also refrain from performing step 508, e.g. the UE 110 does not measure the at least one channel property if there is no reporting the measurement. This may lead to further power savings. In other instances, the UE 110 might always measure the at least one channel property but only report when configured to perform step 510. This may particularly be the case if step 508 is performed before the UE 110 knows whether or not step 510 is to be performed. For example, the UE 110 may measure the channel property using the synchronization signal, but then the paging message subsequently received may indicate that the UE 110 is not to perform a reporting for that paging occasion or wake-up period.

In some embodiments, the UE 110 may receive a message configuring the UE 110 to perform step 508 and/or 510 in relation to a particular wake-up period, paging occasion, or paging operation. For example, the UE 110 may receive a message that configures the UE 110 to perform the reporting (e.g. to perform step 510) during a particular wake-up period. The message might be part of configuration message 501 discussed above in relation to FIG. 12. Alternatively, the message might be one received at a different point in time, e.g. possibly as part of a paging notification or a paging message. For example, the UE 110 might not know, for a given paging operation, whether step 508 and/or 510 of FIG. 9 is to be performed, until the UE 110 is notified during that paging operation or wake-up period. For example, the UE 110 may measure the at least one channel property (perform step 508) using the SS when synchronizing prior to receiving the paging notification. The paging notification or paging message subsequently received may then indicate whether or not the UE 110 is to actually report the measurement (perform step 510). In general, the message configuring the UE 110 to perform step 508 and/or 510 during or for a particular wake-up period, paging occasion, or paging operation may be received in at least one of: RRC signaling; a MAC-CE; a DCI; an SSB; SI, a LP-WUS; a paging notification; or a paging message. In some embodiments, the message may semi-static or dynamic, or a combination of semi-static and dynamic (in which case the message may be distributed over multiple messages), e.g. RRC signaling or MAC-CE to configure the UE 110 to send CSI reports, and DCI to dynamically indicate the instances in which the CSI report is to be sent.

In some embodiments, the message configuring the UE 110 to perform step 508 and/or 510 might indicate other information also, e.g. the message may indicate whether the UE 110 is to perform sensing and/or whether the UE 110 is (or is possibly) being paged. For example, when the UE 110 wakes up in step 502 of FIG. 9, the UE 110 may subsequently receive a message from the TRP 352 that indicates whether the UE 110 is (or is possibly) being paged and/or whether the UE 110 is to perform the measurement and reporting. If the UE 110 is not being paged and the UE 110 does not have to perform the measurement and reporting, then the UE 110 may go back to sleep rather than perform paging operation 504 and steps 508 and 510. If the UE 110 is not being paged but is to perform the measurement and reporting, then the UE 110 may perform steps 508 and 510, but not decode the paging notification or paging message unless required to perform step 508 or step 510.

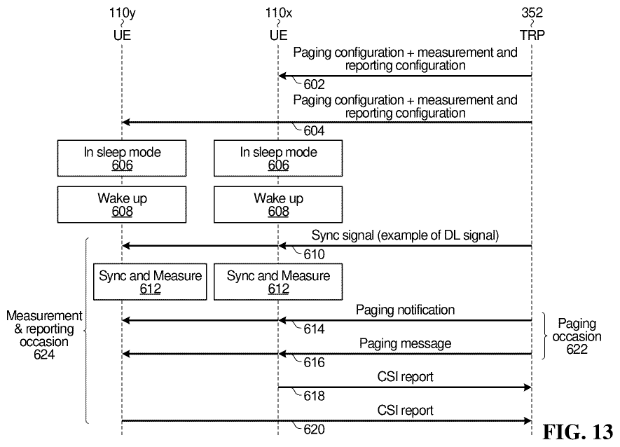

FIG. 13 illustrates an example of FIG. 12 in relation to two UEs 110x and 110y. UEs 110x and 110y may each be in a same paging group. At step 602, the TRP 352 transmits, to UE 110x, the configuration message discussed above in relation to step 501 of FIG. 12. The configuration message configures paging, e.g. it may define the wake-up periods, sleep periods, and/or paging occasions. In this example, the configuration message also configures the measurement and reporting, e.g. it may define the wake-up periods and/or paging occasions for which the UE 110x is to perform the measurement and reporting, and/or it may define which one or more channel properties are to be measured and reported, and/or it may define how the information based on the measurement is to be reported, and/or it may define resources for reporting, etc. A similar message is sent to UE 110y in step 604. In some embodiments, steps 602 and 604 may be a single step in which the message is broadcast or group-cast to UEs 110x and 110y.

At step 606 the UEs 110x and 110y enter into a sleep mode. The method of FIG. 9 then begins for each UE 110x and 110y for a particular paging operation. First, at step 608, UE 110x and 110y each wake up (which is an example of step 502 of FIG. 9). Then, at step 610, the TRP 352 transmits a SS, which is an example of the downlink signal of FIG. 9. The SS may be, for example, an SS in an SSB or a paging reference signal. At step 612, both UE 110x and 110y use the SS to both perform synchronization and measure the at least one channel property. This is an example of step 508 of FIG. 9. A paging notification and paging message is subsequently transmitted by the TRP 352 and received by the UEs 110x and 110y, as shown at steps 614 and 616. At step 618, the UE 110x transmits a CSI report based on its measured at least one channel property, and similarly at step 620 the UE 110y transmits a CSI report based on its measured at least one channel property. The paging notification and/or paging message may be associated with a paging occasion 622. The measurement and reporting may be associated with a measurement and reporting occasion 624. In some embodiments, instead of the UE 110x and 110y measuring the at least one channel property using the SS, the UE 110x and 110y may use a different downlink signal, e.g. a DMRS.

Returning to FIG. 9, and as mentioned earlier, in some embodiments the downlink signal transmitted to the UE 110 in step 506 of FIG. 9 and used by the UE 110 to measure at least one channel property in step 508 may be a synchronization signal (SS). In one example, the SS (e.g. a LP-SS) or the SSB in which the SS is located may also be used to indicate other information. Examples of the other information may include at least one of: whether the UE 110 is to perform step 508 and/or step 510; whether paging will occur for that wake-up period; or one or more ALs for a downlink control channel used to receive the paging notification. For example, for a CORESET area of a PDCCH, there may be 18 PDCCH candidates with different ALS (AL1, 2, 4, 8, 16) defined, and the SSB or LP-SS (using one of multiple SS sequences) may indicate a smaller group of PDCCH candidates (e.g., with AL1 and AL2 only) for UE reduced blind detection of a notification message in DCI.

In some embodiments, the method of FIG. 9 may include receiving a paging notification, such as paging notification 404, as part of the paging operation 504. An example is shown in FIG. 10. In some embodiments, the paging notification indicates at least one of: a time-frequency resource allocation for transmitting the information in step 510; which one or more channel properties are to be reported in step 510 as part of the information; or one or more ALs to be used for a subsequent downlink control channel transmission. In one example, the paging notification may indicate measurement and reporting information, e.g. how and where to send a CSI report in step 510, and/or if the paging message will include a resource allocation for the CSI reporting in step 510, and/or what measurement properties (e.g., RSRP, RSRQ, beam directions or beam orientation info, etc.) are to be included in the CSI report, and/or how the measurements are to be processed (e.g., in terms of information measurement period, average scheme), etc.

In some embodiments, the method of FIG. 9 may include receiving a paging message, such as paging message 406, as part of the paging operation 504. An example is shown in FIG. 10. In some embodiments, the paging message includes UE-specific information indicating whether or not the UE 110 has been paged. In some embodiments, the paging message additionally includes other information that is common for a plurality of UEs, e.g. common to the paging group including UEs 110x, 110y, and 110z. For example, in some embodiments, the paging message additionally includes at least one of the following that is common for a plurality of UEs: a time-frequency resource allocation for transmitting the information in step 510; an indication of which one or more channel properties are to be reported as part of the information in step 510; an indication of one or more ALs to be used for a subsequent downlink control channel transmission; sensing information related to a sensing operation (e.g. a sensing operation to be performed by the group of UEs), e.g. information related to the sensing operation may be configured in the paging message, such as sensing time-frequency resources, and/or sensing target, and/or sensing measurement metrics, and/or sensing report channels, etc.; quasi co-location (QCL) reference signal information; or an indication of timing adjustment (TA) for an uplink transmission (e.g. for uplink transmissions of the group of UEs). In one example, the paging message may include legacy paging information for individual paged UEs and also indicate parameters including time-frequency resources, e.g. PUCCH allocation, to send the CSI report, and/or what measurement properties are to be included in the CSI report, and/or sensing related parameters or sensing time lines, and/or QCL reference signal information, and/or TA or timing reference for uplink transmission, and/or proper AL(s) or default (i.e., initially used) AL(s) to be used for subsequent downlink PDCCH transmissions, etc. In some embodiments, the paging message may indicate, for one or more UEs (or a group of UEs), whether the UE(s) are to perform the reporting (step 510 of FIG. 9).

In some embodiments of FIG. 9, if sensing is also performed by the UE 110 (e.g. the UE 110 is triggered to perform sensing), the sensing measurements/measurement report may also be transmitted to the TRP 352, e.g. as part of step 510 or separately. The sensing measurement report may be transmitted in the same way as any of the ways described herein in which the information in step 510 may be transmitted (e.g. via PUCCH, PUSCH, WUS, RACH, SRS, etc.).

In some embodiments, the method of FIG. 9 may include the UE 110 receiving a LP-WUS transmitted by the TRP 352, e.g. the LP-WUS discussed in relation to step 454 of FIG. 8. The LP-WUS may, for example, be received before the paging notification and it may trigger the UE 110 to switch from a wake-up receiver to a main receiver. In some embodiments, the method of FIG. 9 may include the UE 110 receiving a reference signal transmitted by the TRP 352. The reference signal might, for example, be the downlink signal discussed in relation to steps 506 and 508 of FIG. 9. In some embodiments, the LP-WUS (if present) or the reference signal (if present) may at least one of: trigger the UE 110 to switch to a different transceiver (e.g. like is the case in step 454 of FIG. 8); indicate a location of time-frequency resources in a downlink control channel used to receive a paging notification (e.g. the LP-WUS and/or reference signal may indicate the PDCCH resource location or PDCCH candidates with limited AL(s) such that the UE 110 may monitor and decode the PDCCH with reduced blind detection on PDCCH candidates); trigger the UE 110 to perform measurement and/or reporting (e.g. one or more bits may be added to the LP-WUS control message to indicate to the UE 110 that the UE 110 needs to perform step 508 and/or step 510); or indicate one or more ALs for the downlink control channel used to receive the paging notification. In one example, there may be multiple LP-WUS sequences, (e.g., using short & multiple sequences), any one of which may be used for the LP-WUS signal. A UE 110 may be configured with one or more of multiple LP-WUS signaling options, e.g., indexed notations: each signaling option may represent or correspond to, e.g., a PDCCH AL and/or PDCCH candidate location. The UE 110 may monitor and detect LP-WUS in a LP-WUS occasion and decode a sequence or signaling option among these configured sequence options.

FIG. 9 involves a single UE 110. In general, the paging and measurement and reporting may be for a group of UEs, e.g. each UE in a group may perform the method of FIG. 9 with TRP 352. In some embodiments, a group of UEs, including UE 110, may be part of a paging group, and it might be the case that only some of the UEs in the paging group are configured or indicated to perform measurement and reporting (i.e. to perform steps 508 and 510 of FIG. 9). For example, there may be a semi-static configuration, e.g., via RRC, MAC-CE, etc., or a dynamic indication, e.g., via DCI, indicating which UEs in the paging group are to perform measurement and reporting with respect to one or more paging occasions and/or wake-up periods. Moreover, or alternatively, the paging notification or paging message may indicate or notify one or more UEs of interest in the paging group for measurement and reporting. For example, if the TRP 352 only wants a subset of the UEs to perform the reporting of step 510, then the paging message may indicate which one of those UEs is to perform the reporting of step 510.

A few more specific examples will now be described.

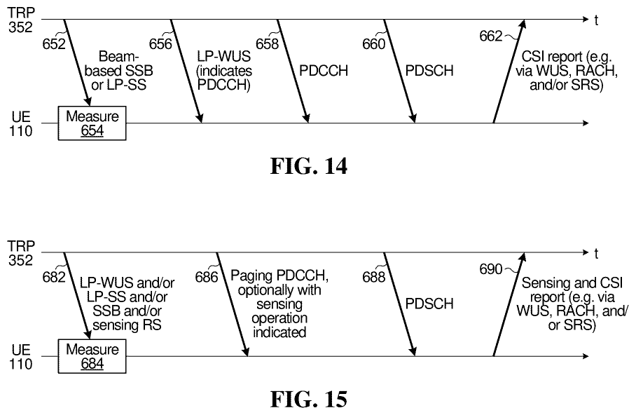

FIG. 14 illustrates one example of FIG. 10, and assuming beam-based transmissions by the TRP 352. At step 652, the TRP 352 transmits a beam-based SSB (having an SS) or a LP-SS. The TRP 352 and/or the UE 110 may be in a power saving mode. Step 652 is an example of step 506 of FIG. 10. The UE 110 is configured in to perform the measurement and reporting, e.g. in relation to a paging occasion associated with the synchronization. Therefore, at step 654, the UE 110 uses the SSB or LP-SS to measure at least one channel property. For example, the UE 110 may measure beam-based RSRP, CQI, etc. Step 654 is an example of step 508 of FIG. 10. In some embodiments, multiple different beams may be transmitted by the TRP 352 and received by the UE 110, and the UE 110 may perform the channel measurement on each of those beams. In some embodiments, the SSB or LP-SS may indicate if a paging occasion is present or not. In some embodiments, the SSB or LP-SS may also or instead indicate, to the UE 110, one or more ALs to be used for a subsequent PDCCH, e.g. the PDCCH carrying the subsequent paging notification. This may reduce the amount of blind detection needed by the UE 110 because the UE 110 may monitor and detect the paging PDCCH with the AL(s) indicated by SSB or LP-SS. At step 656, the TRP 352 transmits a LP-WUS, e.g. which causes the UE 110 to switch from a wake-up receiver to a main receiver. In some embodiments, the LP-WUS may indicate the time-frequency location of the PDCCH and/or the LP-WUS may indicate whether or not the PDCCH (carrying the paging notification) is present. In some embodiments, the LP-WUS is omitted, e.g. if the UE 110 does not need to switch from a wake-up receiver to a main receiver. At step 658, the TRP 352 transmits a paging PDCCH at the time-frequency location. The paging PDCCH carries the paging notification. The UE 110 monitors and detects the paging PDCCH with the indicated AL(s), which reduces PDCCH blind detection. The paging notification indicates the resource allocation for the PDSCH. At step 660, the TRP 352 transmits the PDSCH carrying the paging message. Steps 658 and 660 are an example of step 507 of FIG. 10. At step 662, the UE 110 transmits a CSI report based on the measurement of step 654. Step 662 is an example of step 510 of FIG. 10. The reporting of step 662 may occur even if the UE 110 is not paged in the paging message. In some embodiments, the CSI report is transmitted by the UE 110 in step 662 by transmitting a particular wake-up signal (WUS) sequence, or by transmitting a particular sounding reference signal (SRS), or during a RACH procedure. The method of FIG. 14 may be considered an enhanced paging procedure that may occur in a power saving mode, e.g. an inactive or idle mode or state.

FIG. 15 illustrates another example of FIG. 10, and assuming the UE 110 is also configured to perform sensing. At step 682, the TRP 352 transmits a LP-WUS and/or a LP-SS and/or an SSB (e.g. having a SS) and/or a sensing reference signal. Step 682 is an example of step 506 of FIG. 10. If the TRP 352 at least transmits a LP-WUS, then the UE 110 monitors a LP-WUS occasion and detects the LP-WUS. The LP-WUS optionally triggers the UE 110 to switch to a main receiver. The LP-WUS optionally indicates whether the paging PDCCH (that carries the paging notification) is present or not. If the TRP 352 transmits a sensing reference signal, it may be configured to have a QCL relationship with the communication group/cell-based signals, such as SSB or LP-SS.

At step 684, the UE 110 may perform a measurement of at least one channel property using one or more of the downlink signal(s) transmitted by the TRP 352 in step 682. Step 684 is an example of step 508 of FIG. 10. At step 686, the TRP 352 transmits the paging PDCCH carrying a paging notification. The paging PDCCH may optionally also indicate that the UE 110 is to perform sensing, e.g. the downlink notification in the PDCCH may notify paging and trigger sensing. The PDCCH may be a group-based DCI control message. The UE 110 may search and monitor for the control message at a particular time-frequency location. The time-frequency location may be indicated by the LP-WUS signaling or by a previously received reference signal. At step 688, the TRP 352 transmits a PDSCH carrying a paging message. Optionally, the paging message may carry detailed sensing configuration information, e.g. indicating what type of sensing should be performed, and/or timing of the sensing, and/or resources for transmitting the sensed results to the TRP 352, etc. Steps 686 and 688 are an example of step 507 of FIG. 10. At step 690, the UE 110 transmits a sensing report (assuming sensing was performed by the UE 110) and the CSI report. The sensing report and/or CSI report may be transmitted in a WUS, a SRS, or part of a RACH procedure, as an example. Step 690 is an example of step 510 of FIG. 10. FIG. 15 is an example in which group sensing may utilize the already-existing paging procedure to save power, e.g. for sensing in a power saving mode, such as in an inactive or idle state.

Control signaling and blind detection reduction will now be described in more detail, including explaining in more detail below how some embodiments herein may assist with reducing blind detection.

One type of control signaling message in a wireless network is scheduling messages. Scheduling messages may include DCI for dynamically scheduling or granting downlink and/or uplink transmission time-frequency resources, as well as other transmission related parameters in a downlink control channel, such as a PDCCH. A PDCCH may be transmitted in a time-frequency resource region to carry a scheduling message. The time-frequency resource region used for a PDCCH can be pre-defined (e.g., using fixed or tabulated rules), determined based on system information (SI) or configured, for example, via RRC. An example of PDCCH is the PDCCH described herein that carries a paging notification.

The PDCCH may be one of a set of PDCCH candidates defined over the time-frequency resource region. The set of PDCCH candidates is referred to as a control resource set (CORESET). There are often more than one PDCCH candidate in a CORESET for one UE or for a group of UEs. Each PDDCH candidate may be configured to have different encoding or redundant transmission versions to support the UE or group of UEs, as the UE or group of UEs may be located in different geographical locations within a cell due to UE mobility and a changing wireless channel environment. As a result, the UE or group of UEs may need to monitor scheduling messages received from the network and detect an incoming PDCCH blindly, i.e., by trying different PDCCH candidates until the detection is successful. A UE specific Radio Network Temporary Identifier (RNTI) or a group RNTI (e.g., semi-statically configured before communication) may be used to scramble the Cyclic Redundancy Check (CRC) of the incoming PDCCH payload (e.g., DCI).

In new radio (NR) networks, including 5G networks, a CORESET may consist of 1, 2, or 3 symbols and one or more resource blocks (RBs) in a frequency domain. For example, there may be 24, 48 or 96 RBs for initial access procedures and up to 275 RBs for UE specific transmissions.

PDCCHs fall into three categories according to their application scenarios and functions: common PDCCHs, group common PDCCHs and UE-specific PDCCHs. A common PDCCH is used for transmitting common messages (such as system information RMSI/OSI) and scheduling data (e.g., 4-step RACH (random access channel) Msg2/Msg4) before an RRC connection to the UE is established. A group common PDCCH is used for scheduling a group of UEs, e.g., scheduling the slot format (SFI) for a UE group. A UE-specific PDCCH is used for scheduling the UE-specific data and power control information.

As a PDCCH can carry scheduling and control messages, which are critical communication messages in downlink and/or uplink transmission, it should be reliable enough to guarantee the reception at the receiving end (e.g., the UE side). In an NR network, an encoding or redundant transmission version may include aggregation levels (ALs), as discussed earlier. For example, an AL of a PDCCH candidate may be any one of AL1 (aggregation level 1), AL2, AL4, AL8 and AL16, where a PDCCH candidate with AL1 may take one control channel element (CCE) that consists of six physical resource blocks (PRBs), and a PDCCH candidate with ALx>1 may take a time-frequency resource of x CCEs to encode a DCI. A common PDCCH or group common PDCCH may be pre-defined or configured with, for example, AL4, AL8 or AL16 while a UE-specific PDCCH may be configured with, for example, AL1, AL2, AL4, AL8 or AL16. A PDCCH with a higher aggregation level may use more resources and hence, may be more reliable. For example, AL16 may use 16 times the amount of the resources used by AL1, so a PDCCH with AL16 can have much more robust channel encoding resulting in more reliable transmission than a PDCCH with AL1.

One or more PDCCH candidates can be configured for each AL. If, for example, up to 8 PDCCH candidates are configured for each AL, there may be up to 48 PDCCH candidates that need to be monitored and blindly detected by the UE(s) for an incoming PDCCH upon transmission of each DCI. Blindly detecting an incoming PDCCH for each scheduling occasion may consume a lot of time and resources. Furthermore, the network may transmit unnecessary redundant signals, requiring more power consumption, as a conservative way to achieve a reliable transmission of crucial control message if the network does not know the channel conditions or an accurate location of the UE.

As a result, there is a need to find ways of reducing the need for blind detection on PDCCH and of saving resources and power.

In some embodiments of FIG. 9 explained herein, blind detection of a PDCCH may be reduced. For example, as explained earlier, in some embodiments the UE 110 may, based on the measured at least one channel property (such as SNR), determine a reduced set of ALs and indicate those to the TRP 352. The TRP 352 may then use those reduced set of ALs for a subsequent PDCCH transmission, e.g. when transmitting the paging notification. Because the set of ALs is reduced, blind detection by the UE 110 may be reduced. In another example, a reduced set of ALs to use for future PDCCH transmissions are indicated by the TRP 352 to the UE 110 in a downlink transmission. The UE 110 may then perform blind detection on the PDCCH using the reduced set of ALs, thereby reducing the amount of blind detection needed to be performed by the UE 110.

The method of FIG. 9 and its various examples and variations are all explained in relation to a UE 110 and a TRP 352. However, these embodiments are not limited to a UE and TRP. For example, instead of a UE, a NT-TRP may be paged and may perform the measurement and reporting. As another example, instead of a TRP, a “master UE” operating on behalf of the network may page other UEs and send the downlink signal. Therefore, in all of the embodiments described above, the UE 110 may be replaced with “apparatus” and the TRP 352 may be replaced with “device”, where “apparatus” and “device” are simply different labels to more easily distinguish between two entities. The apparatus could be a UE, but it does not have to be (e.g. it could be a NT-TRP). The device could be a TRP, but it does not have to be (e.g. it could be another network device, or it could be a master UE operating on behalf of the network).

### SOME SPECIFIC EXAMPLES

The following are some specific examples commensurate with embodiments discussed herein. The following is not meant to be limiting.

One type of control signaling message in a wireless network is scheduling messages. Scheduling messages may include downlink (DL) control information (DCI) for (dynamically) scheduling or granting DL and/or uplink (UL) transmission time-frequency resources as well as other transmission related parameters in a DL control channel, such as a PDCCH (physical DL control channel). A PDCCH may be transmitted in a time-frequency resource region to carry a scheduling message. The time-frequency resource region used for a PDCCH can be pre-defined (e.g., using fixed or tabulated rules), determined based on system information (SI) or configured, for example, via RRC (radio resource control). The PDCCH may be one of a set of PDCCH candidates defined over the time-frequency resource region. The set of PDCCH candidates is referred to as a control resource set (CORESET). There are often more than one PDCCH candidate in a CORESET for one UE or for a group of UEs. Each PDDCH candidate may be configured to have different encoding or redundant transmission versions to support the UE or group of UEs as the UE or group of UEs may be located in different geographical locations within a cell due to UE mobility and changing wireless channel environment. As a result, the UE or group of UEs may need to monitor scheduling messages received from the network and detect an incoming PDCCH blindly, i.e., by trying different PDCCH candidates until the detection is successful. A UE specific RNTI (Radio Network Temporary Identifier) or a group RNTI (e.g., semi-statically configured before communication) may be used to scramble the CRC (Cyclic Redundancy Check) of the incoming PDCCH payload (e.g., DCI).

In NR (new radio) networks, including 5G networks, a CORESET may consist of 1, 2, or 3 symbols and one or more RBs (resource blocks) in a frequency domain. For example, there may be 24, 48 or 96 RBs for initial access procedures and up to 275 RBs for UE specific transmissions.

PDCCHs fall into three categories according to their application scenarios and functions: common PDCCHs, group common PDCCHs and UE-specific PDCCHs. A common PDCCH is used for transmitting common messages (such as system information RMSI/OSI) and scheduling data (e.g., 4-step RACH (random access channel) Msg2/Msg4) before an RRC connection to the UE is established. A group common PDCCH is used for scheduling a group of UEs, e.g., scheduling the SFI (slot format) for a UE group. A UE-specific PDCCH is used for scheduling the UE-specific data and power control information.

For a paging operation, a paging group of UEs may be in a sleep mode for a period of duration, periodically wake up on paging occasions, detect a paging notification (or a DCI) that is carried by a common PDCCH and possibly receive a paging message in a physical DL shared/data channel (PDSCH) whose time-frequency resource is scheduled by the paging notification. Due to a plurality of PDCCH candidates with one or more ALs defined/configured within a CORESET, UEs in the paging group may need blind detections on a PDCCH among the plurality of PDCCH candidates in each paging occasion. The sleep mode here is defined as a situation where, for example, a UE may have no activity for transmission and reception and try to keep a minimum power usage for a transceiver background operation or even turn off the transceiver.

As a PDCCH can carry scheduling and control messages, which are critical communication messages in DL and/or UL transmission, it should be reliable enough to guarantee the reception at the receiving end (e.g., the UE side). In an NR network, an encoding or redundant transmission version may include schemes referred to as aggregation levels (AL). For example, an aggregation level of a PDCCH candidate may be any one of AL1 (aggregation level 1), AL2, AL4, AL8 and AL16, where a PDCCH candidate with AL1 may take one control channel element (CCE) that consists of six physical resource blocks (PRBs), and a PDCCH candidate with ALx>1 may take a time-frequency resource of x CCEs to encode a DCI. A common PDCCH or group common PDCCH may be pre-defined or configured with, for example, AL4, AL8 or AL16 while a UE-specific PDCCH may be configured with, for example, AL1, AL2, AL4, AL8 or AL16. An PDCCH with a higher aggregation level may use more resources and hence, may be more reliable. For example, AL16 may use 16 times the amount of the resources used by AL1, so a PDCCH with AL16 can have much more robust channel encoding resulting in more reliable transmission that a PDCCH with AL1.

One or more PDCCH candidates can be configured for each AL. If, for example, up to 8 PDCCH candidates are configured for each AL, there may be up to 48 PDCCH candidates that need to be monitored and blindly detected by the UE(s) for an incoming PDCCH upon transmission of each DCI. Blindly detecting an incoming PDCCH for each scheduling occasion may consume a lot of time and resources. Furthermore, the network may transmit unnecessary redundant signals, requiring more power consumption, as a conservative way to achieve a reliable transmission of crucial control message if the network does not know the channel conditions or an accurate location of the UE.

As a result, there is a need to find ways of reducing the need for blind detection on PDCCH and of saving resources and power.

Moreover, before receiving each paging notification, each UE in a same paging group may need to perform DL synchronization, for example, synchronized with DL reference signal(s), and thus having a certain degree of channel measurements. These channel measurements may have potential values in helping network for more effective control and operation; however, in current networks, these potential and useful measurement results from the paging group of UEs in each paging occasion are not used, leading to a wastage of these information (which, otherwise, can be reported to and help network control optimization).

A legacy network on paging a group of UEs is performed in the following: each UE in the paging group may need to first get DL synchronization ready by, e.g., synchronizing DL reference signals, before a paging occasion, and then receive paging notification signaling (or a DCI) in the paging occasion to get a scheduling information and further receive paging message in time-frequency resource provided in the scheduling information. Based on received paging message, a UE may perform further operations, if paged, such as transceiver type switching or/and RRC state transition for DL traffic reception or starting a UL transmission.

FIG. 8 is an example on group paging procedure: a UE in a paging group may work with a low-cost transceiver, WUR (wake-up receiver) and before a paging occasion, it may wake up to synchronize with DL reference signals (e.g., Sync RS (labeled as SS) in FIG. 8) and get ready to receive the paging notification and paging message from LP-WUS (low-power wake-up-signal) of a base station. For a UE paged in the paging message, it may switch to a normal transceiver, MR (main receiver), and to perform a UL random access to the base station.

It is noted that UEs in the paging group have to perform synchronization with DL reference signals, and each individual may have its own channel measurement information (during the synchronization procedure, for example using NR PSS and SSS). But if a UE is not paged, such measurement information during the synchronization is simply discarded, which can be a loss of useful information to the network control optimization.

The paging procedure in current networks may simply discard measurement information from the synchronization if UEs in a paging group/subgroup are not paged, which can be a loss of potentially useful information, and otherwise may be used for more effective network control and operation such as an optimized scheduling, interference mitigation, etc.

Schemes are proposed in some embodiments herein to avoid the information wastage, and an efficient way to use this information for sensing or communication.

In future wireless network, power saving is one of criteria that to take consideration as one of performance metrics. For example, a UE or/and a base station may operate with DRX (Discontinuous Reception) or/and DTX (Discontinuous Transmission), where the UE or base station may be in a sleep mode most of the time and wake up periodically to receive or transmit information on demand.

Paging operation is one of popular functionalities associated with DRX or DTX. For example, a group of UEs or devices in a sleep mode may wake up to receive a paging message in a paging occasion (among configured periodic occasions). To receive the paging message for the group of UEs, each UE in the paging group has to perform DL synchronization over, e.g., system synchronization signals or reference signals such as NR SSB, which may naturally measure or be able to derive the channel conditions or quality. These channel measurements by a UE in a paging group may happen when performing DL synchronization (before receiving a paging notification or DCI), or/and when receiving associated paging message. In the latter situation, for a UE in the paging group to receive the paging message, a channel estimation can be performed using DMRS in transmission with the paging message, so the UE may have well estimated knowledge of its own channel conditions or quality.

Such channel conditions or quality by multiple UEs may be valuable for network to perform effective or optimized operations, such as effective transmission scheduling, interference avoidance or mitigation for communication or/and sensing. The communication here is referred to as normal traffic transmission and reception on control messages or/and data messages, while sensing is referred to as channel sounding or estimation to obtain UE/object geographic information or channel conditions/quality.

As a result, configuration and signaling procedures are proposed to use such measurement information from UEs in a paging group, where the measurement information is done via measuring the broadcast or cell-common reference signals in a paging occasion before receiving paging notification or/and via measuring DRMS in transmission with a paging message.

In some embodiments, the time when the network instructs UEs in a paging group to report their measurements is configurable; for example, there is no need to report in every paging occasion to save power. The detailed scheme and design are given in the table below:

| QCL options | Description |
|---|---|
| Type-A | Doppler shift, Doppler spread, average delay, |
| | delay spread |
| Type-B | Doppler shift, Doppler spread, etc. |
| Type-C | Doppler shift, average delay, etc. |
| Type-D | Spatial Rx parameter, etc. |

Upon a UE wake-up and synchronization with network over one or more DL reference signals such as SSB(s), paging reference signal(s), sensing (reference) signals, etc., the UE can be configured on certain measure metrics that can be used by the network. One measurement metric may include RSRP (Reference Signal Received Power), RSRQ (Reference Signal Received Quality), and SINR (Signal to Interference & Noise Ratio) that are typical and important parameters used to measure the quality of a cellular network signal and channel, specifically, RSRP measures the average power received from a reference signal. For example, its typical range is around −44 dbm (good) to −140 dbm (bad); RSRQ measures the quality of the received signal, and its range is, for example, −19.5 dB (bad) to −3 dB (good); and SINR is the signal-to-noise ratio of the given signal, a measure of signal quality as well. Moreover, CQI (channel quality indicator) can be another metric on channel quality measurement that can be used to optimize the usage of, e.g., modulation and coding schemes. These metrics provide a big picture of one or more UEs on its/their geographic information or/and channel conditions/quality.

Besides, by configuration, channel characteristics such as Doppler shift, Doppler spread, average delay, delay spread can also be measured for a UE in a power saving mode. In some cases, more reference signals can be measured with QCL relationship to report in the power saving mode or during sleep cycle and/or wake-up for a paging occasion. QCL stands for Quasi Co-Location and refers to the relationship between different reference signals (RS) in a cell1. The quasi co-location relationship is configured by the higher layer (e.g., RLC) parameter qcl-Type1 for the first DL RS and qcl-Type2 for the second DL RS (if configured). For the case of two DL RSs, the QCL types shall not be the same, regardless of whether the references are to the same DL RS or different DL RSs. The common QCL types include Type-A, Type-B, Type-C, and Type-D as described in the table above.

One or more paging occasions can be configured or indicated for a UE to report these measurement metrics, or a CSI report, to a base station or network. The configuration on paging, measurement and reporting (time) occasions can be made in a semi-static way, via RRC, MAC-CE, in a dynamic way, via DCI, or a combination of thereof. There are a few options to inform UEs in a paging group (or sub-group) to send a CSI report in one or more paging occasions: 1) RRC configuration or MAC-CE notification (e.g., in DL data transmission); 2) DCI notification (or indication); 3) using both RRC and DCI to notify the UEs in the paging group.

A UE in a paging group that are to send a CSI report in a paging occasion may measure the configured DL reference signals, including QCLed reference signals. It is not necessary for the UE to do so on the other paging occasions when the CSI report is not needed (or indicated), thus leading to a power saving.

In future wireless network, there can be at least two types of transceivers: 1) transceiver with low cost (or lower power usage); 2) A (legacy or normal) transceiver with normal cost (or relatively higher power usage). For example, a base station may have LP-WUS (low-power wake-up signal transceiver) and a normal transceiver; a UE may have low cost transceiver such as WUS/WUR (wake-up signal/wake-up reception) and a normal transceiver such as MR (Main transceiver).

Once UEs in a paging group are notified for a CSI report in a paging occasion, a few schemes can be used to send the CIS report, e.g.:
PUCCH
UL data piggyback
RACH
Low-cost transceiver or normal transceiver.

A notification for UEs to report CSI report in a paging occasion can be semi-statically or dynamically configured or indicated, where associated time-frequency resources for a PUCCH can be allocated to transmit the CSI report, for example, the time-frequency resources are allocated via RRC, DCI, etc., or carried in the paging message.

In other example, a CSI report in a paging occasion can be piggybacked in a UL data transmission for a UE in the paging group, where the UL data transmission may or may need the UE from the paging group for an operational state transition, for example, the UE in the paging group in Inactive state, its UL data transmission may be performed in the Inactive state, and no need to transition to Active (or Connected) state.

If no PUCCH is configured at the moment when the CSI report is to send, a UE in a paging group may be able to perform a random access procedure, via 4-step RACH or 2-step RACH, and the CSI report can be transmitted in PUSCH channel in the random access procedure. Specifically, the CSI report on the measurement metrics can be carried in Message 3 in 4-step RACH process and MsgA in 2-step RACH process.

Moreover, a UE in a paging group may operate using normal transceiver, such as legacy transceiver, where the CSI report may be sent via the normal transceiver, or alternatively, the UE may switch to a low-cost transceiver such as WUS or WUR, for transmission of the CSI report. In some example, a base station may use a normal transceiver such as legacy transceiver for paging operation and DL reference signal(s) such as SSB, CSI-RS, etc, for DL synchronization where the UE may measure the channel characteristics at least based on the DL reference signal(s). In other embodiments, a UE in a paging group may operate using low-cost transceiver, such as WUS or WUS, where the CSI report may be sent via the low-cost transceiver; alternatively, the UE may switch to a normal transceiver for transmission of the CSI report. In some example, a base station may use a low-cost transceiver such as LP-WUS for paging operation send LP-SS (low power-synchronization signal) for DL synchronization where the UE may measure the channel characteristics at least based on the LP-SS.

There are multiple possible embodiments/implementations to achieve the proposed goals or solutions, which are described briefly here and detailed in the following individual embodiment sections.

### UE Measurement and Reporting Procedure in a Paging Occasion:

UE measurement and reporting procedure in a paging occasion is provided as shown in FIG. 13. Initially, a base station (illustrated as a TRP in FIG. 13) may perform paging configuration as well as measurement and reporting configuration, where the measurement metrics are defined and some related values such as metric threshold values are provided. The configuration on paging, measurement and reporting (time) occasions can be made in a semi-static way, via RRC, MAC-CE, in a dynamic way, via DCI, or a combination of thereof. Such a configuration can be done either in Inactive or idle state (where a UE may stay silent or in a sleep mode) or in Active or Connected state (where a UE may communicate traffic actively with network).

In FIG. 13, a DRX/DTX configuration is performed for UEs in a paging group, and the UEs in the paging group may go into sleep mode and wake up periodically for a paging occasion. Before receiving a paging notification and a paging message in the paging occasion, the UE may wake up to perform DL synchronization with, e.g., SSB or a paging RS, and then receive a paging notification or paging-group based DCI that schedules time-frequency resources of PDSCH (physical downlink shared channel) where the paging message is transmitted. The paging notification or the paging-group based DCI may indicate measurement and reporting information: for example, how and where to report CSI on the measurements, if the paging message including any resource allocation for CSI reporting, what measurement metrics (e.g., RSRP, RSRQ, beam directions or beam orientation info, etc.) being included in the CSI report, and how the measurements being processed (e.g., in terms of information measurement period, average scheme), etc.

The paging message may include legacy paging information for individual (paged) UE, but also comprise parameters including time-frequency resources, e.g., PUCCH allocation, to report CSI information, what measurement metrics included, sensing related parameters or sensing time lines, QCL reference signal information, time adjustment (TA) or timing reference for UL transmission, proper AL(s) or default (i.e., initially used) AL(s) to be used for following DL PDCCH transmissions, etc.

In FIG. 13, such as a paging occasion is indicated to report measurement metrics as a CSI report. After individual UE has processed the measurements as configured or indicated by a BS, a UE may send the CSI report via, e.g., PUCCH, RACH channel, piggybacked in UL data transmission; the UE may use low-cost transceiver, normal transceiver, or a combination of two types of the transceivers for the CSI report.

In above procedure, CSI reporting rate can be at most same as paging cycle or paging rate or multiples of paging cycles; alternatively, any specific paging occasions may be configured or indicated for an aperiodic CSI reporting, for example, a DCI may indicate the CSI report on demand. In some embodiments, there are a few options to inform UEs in a paging group (or sub-group) to send a CSI report in one or more paging occasions: 1) RRC configuration or MAC-CE notification (e.g., in DL data transmission); 2) DCI notification (or indication); 3) including an indication in the paging message, 4) using a combination of above schemes to notify the UEs in the paging group.

In other examples, the group measurement and CSI reporting can be indicated by a notification message, e.g., in DCI, which may include a new field or modified field to add one or more bits in a DCI format as the notification or in LP-WUS, where one or more new bits can be added to LP-WUS control message for the notification. Moreover or alternatively, PDCCH aggregation level (AL) can also be indicated in above notification message or in paging message to indicate proper AL(s) or default AL(s) to be used for DL PDCCH transmissions.

In another example, a simplified CSI report is provided by UEs in a paging group at a paging occasion. For example, a WUS with one of multiple transmission sequences is to indicate a different signal strength, a WUS with measurement metric per beam is sent where per beam direction information is also provided, UE indicates different channel conditions or quality by sending UL SRS signals with different SRS sequences. It is possible that a CSI report is transmitted staying the same state and without a state transition, e.g., from Inactive state to connected state.

In another embodiment, part of UEs in a paging group are configured or indicated to provide channel measurements and CSI reports. For example, there can be a semi-static configuration, e.g., via RRC, MAC-CE, etc., or a dynamic indication, e.g., via DCI, on the part of UEs in the paging group for measurement and CSI reporting in one or more paging occasions. Moreover or alternatively, the paging message may indicate or notify one or more UEs of interest in the paging group for measurement and CSI reporting.

For sensing and communication, sensing or/and communication can also be indicated with the CSI reporting notification or indication. For example, the paging message may include bits to indicate incoming sensing or/and communication operation; also, LP-WUS, DCI, or even SSB can be used to indicate sensing or/and communication operation. Sensing RS(s) and communication RS(s) can be used for measurements and report in a paging occasion. For example, sensing specific RS can be configured to QCLed with communication group/cell based RSs such as SSB or LP-SS. A UE in a paging group may report the measurement metrics as a CSI report, regardless if the UE is paged or not. Part of UEs in a paging group configured or indicated for the channel measurement and CSI reporting can be of significance to help sensing operations or enhance an integrated sensing and communication.

Paging Procedure with Signal Measurements in a Power Saving Mode and Reduced PDCCH Detection:

As shown in FIG. 14, a UE in a paging group may measure reference signal, e.g., from SSB or paging DL synchronization, and report the measurement metrics while PDCCH candidates can be indicated with aggregation level information to reduce the blind detection of PDCCH candidates in a PDCCH monitoring occasion.

The measurement (CSI) report is for each paged beam, or a set of beams for paging operations. For a high frequency bands such as millimeter wave frequency band, paging operation may try to send SSB in different beams, each beam may coverage specific areas. In such a case, UEs in a paging group may be able to detect and measure DL RS(s) in different beams, and each UE may measure the RS(s) with different signal strengths and channel characteristics. Thus, reporting information on the measurement per beam from each UE in the paging group may provide big picture on the UE distribution and channel quality over sweeping beams from the network or a base station.

In some example, a UE in a paging group may be configured to report all the measurements from all beams on a basis of per beam information; or a UE in a paging group may be configured to report the configurable number of strongest beams. The reporting may be transmitted from a UE in power saving mode (e.g., Inactive or Idle state) with or without transition to other power mode (e.g., connected state).

UE(s) in a configured paging occasion perform measurement on beam based SSB or LP-SS, e.g., beam based RSRP, CQI, etc, and CSI reporting; also, SSB/LP-SS may indicate if the paging occasion is present or not; or/and may indicate PDCCH AL(s) to the UE. Note that the CSI reporting may include appropriate AL(s), one per beam measurement basis, for following PDCCH transmissions, where AL indication may optionally use reference signals with multiple sequences, each mapping to one aggregation level from, e.g., AL1, AL2, AL4, AL8, AL16, etc.

After synchronization with DL RS(s), e.g., SSB, LP-SS, etc., UE may monitor and detect paging-based PDCCH with the AL(s) indicated by SSB or LP-SS to achieve reduced PDCCH blind detection. From the detection of PDCCH, the UE may obtain resource allocation for PDSCH that carries the paging message.

UE metric or CSI reporting can be done through WUS, PUCCH, RACH or/and SRS as described in previous paragraphs above. Note that the UE CSI report may happen even if no paging message present in this paging occasion, where the measurements may be based on DL RS(s) such as SSB, LP-SS, etc.

Paging Operation with Effective (Group) Sensing:

For sensing and communication, sensing or/and communication can also be indicated with the CSI reporting notification or indication. For example, the paging message may include bits to indicate incoming sensing or/and communication operation; also, LP-WUS, DCI, or even SSB can be used to indicate sensing or/and communication operation. Sensing RS(s) and communication RS(s) can be used for measurements and report in a paging occasion. For example, sensing specific RS can be configured to QCLed with communication group/cell based RSs such as SSB or LP-SS. A UE in a paging group may be notified to report the measurement metrics as a CSI report, regardless if the UE is paged or not; for example, the UE in the paging group can be configured in a semi-static way to report the measurement metrics or can be notified in the paging message for the CSI reporting; in this way, a UE involved in a sensing UE group may be configured or notified to measure the sensing or communication reference signals and report the measurement metrics in configured paging occasion(s) when the UE is in a power saving mode (e.g., Inactive or Idle state) and with a paging group. As a result, part of UEs in a paging group configured or indicated for the channel measurement and CSI reporting can be of significance to help sensing operations or enhance an integrated sensing and communication.

FIG. 15 shows a paging operation procedure with CSI reporting for sensing, where a UE in a paging group with DRX configuration may wake up and detect DL reference signal(s) such as LP-WUS (e.g., with sequence transmission), LP-SS, SSB, a paging reference signal, or sensing signal (or sensing reference signal). The UE may measure reference signals over multiple beams and report one or more spatial/beam directions among multiple beams. For sensing signal or sensing specific RS, the sensing operation can be configured to QCL with communication group/cell based RSs such as SSB or LP-SS. Moreover or alternatively, the LP-WUS and/or reference signal(s) may trigger a UE operating with low-cost transceiver to switch to normal transceiver such as MR in order to have more communication capability; also, the LP-WUS and/or reference signal(s) may indicate the PDCCH resource location or PDCCH candidates with limited AL(s) such that the UE may monitor and decode the PDCCH with reduced blind detection on PDCCH candidates. For a sensing operation, the detailed or additional sensing configuration, such as sensing time-frequency resources, sensing target, sensing measurement metrics, sensing report channels, etc., can be carried by paging message.

In some embodiments, multiple LP-WUS sequences, e.g., using short & multiple sequences, may be used for LP-WUS signal. A UE is configured with one or more of multiple LP-WUS signaling options, e.g., indexed notations: each signaling option may represent or corresponding to, e.g., an PDCCH AL and/or PDCCH candidate location. The device/UE may monitor and detect LP-WUR in a LP-WUS occasion and decode a sequence or signaling option among these configured sequence options.

Such a paging operation with CSI reporting for sensing operation may be applicable to both power saving mode, e.g., Inactive state, and a normal power operation mode, e.g., connected state.

When a UE measures sensing signal(s) or sensing reference signal(s) over a paging procedure, the resulting measurement metrics is referred to as sensing measurements, and the measurement report can be sent same as previously described, for example, via WUS, PUCCH, RACH or/and SRS. Multiple nodes or UEs involved in sensing may form a sensing group or a group sensing, and the group sensing may take use of paging procedure for measurement and reporting, thus able to save power for sensing in power saving mode such as Inactive, Idle state, etc.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Consistent with the above, the expression “at least one” means one or more. The expression “a plurality of” means two or more. The expression “and/or” describes an association relationship of associated objects, and indicates that there may be three relationships. For example, A and/or B may indicate “only A”, “both A and B”, or “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

The present disclosure encompasses various examples, including not only method examples, but also other examples such as apparatus examples and examples related to non-transitory computer readable storage media. Examples may incorporate, individually or in combinations, the features disclosed herein. Although this disclosure refers to illustrative examples, this is not intended to be construed in a limiting sense. Various modifications and combinations of the illustrative examples, as well as other examples of the disclosure, will be apparent to persons skilled in the art upon reference to the description.

Features disclosed herein in the context of any particular examples may also or instead be implemented in other examples. Method examples, for example, may also or instead be implemented in apparatus, system, and/or computer program products. In addition, although examples are described primarily in the context of methods and apparatus, other implementations are also contemplated, as instructions stored on one or more non-transitory computer-readable media, for example. Such media could store programming or instructions to perform any of various methods consistent with the present disclosure.

In the disclosure, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

In the disclosure, the words “first”, “second”, etc., when used before a same term (e.g., ED, or an operating step) does not mean an order or a sequence of the term. For example, the “first ED” and the “second ED”, means two different EDs without specially indicated, and similarly, the “first step” and the “second step” means two different operating steps without specially indicated, but does not mean the first step have to happen before the second step. The real order depends on the logic of the two steps.

The terms “coupled”, “coupling” or “connected” as used herein may have several different meanings depending on the context in which these terms are used. For example, as used herein, the terms coupled, coupling, or connected may indicate that two elements or devices are directly connected to one another or connected to one another through one or more intermediate elements or devices via a mechanical element depending on the particular context.

The term “receive”, “detect” and “decode” as used herein may have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive”, “detect” and “decode” may indicate different procedure at receiving side to obtain the information. In some scenarios, if an apparatus implementing a method described herein is an integrated circuit, the term “receive” may mean “input” or “obtain”, and the term “transmit” may mean “output.”

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
waking from a sleep mode to perform a paging operation;
during the paging operation, measuring at least one channel property using a downlink signal, to obtain a measured at least one channel property; and
transmitting information to a device based on the measured at least one channel property.

2. The method of claim 1, wherein the downlink signal is received on a first beam, and wherein measuring the at least one channel property using the downlink signal comprises performing per-beam measurement during the paging operation by:
measuring the at least one channel property for the first beam using the downlink signal received on the first beam, to obtain a measured at least one channel property for the first beam; and
for each beam of one or more other beams: receiving a corresponding downlink signal on that beam and measuring the at least one channel property for that beam using the corresponding downlink signal received on that beam, to obtain a measured at least one channel property for each of the one or more other beams; and
wherein the information transmitted is based on the measured at least one channel property for the first beam and the measured at least one channel property for each of the one or more other beams.

3. The method of claim 1, wherein multiple downlink signals, including the downlink signal, are received during the paging operation, wherein the multiple downlink signals have a quasi co-location (QCL) relationship with each other, and wherein measuring the at least one channel property comprises measuring the at least one channel property using at least one of the multiple downlink signals.

4. The method of claim 1, further comprising receiving a message configuring one or more paging operations, wherein the message further configures at least one of:
one or more wake-up periods during which an apparatus is to transmit the information based on the measured at least one channel property;
one or more paging occasions for which the apparatus is to transmit the information;
the at least one channel property that is to be measured;
which one or more channel properties are to be reported as part of the information;
a manner in which the information is to be transmitted; or
uplink time-frequency resources used to transmit the information; and
wherein the message configures the one or more paging operations by at least configuring at least one of:
one or more wake-up periods;
one or more sleep periods;
a paging discontinuous reception (DRX) cycle; or
one or more paging occasions in a wake-up period.

5. The method of claim 1, wherein transmitting the information includes at least one of:
transmitting the information in an uplink control channel;
transmitting the information in an uplink data channel;
transmitting the information during a random access procedure;
transmitting the information in a wake up signal (WUS); or
transmitting the information in an uplink reference signal.

6. The method of claim 1, further comprising:
receiving a paging message during the paging operation, wherein the paging message includes apparatus-specific information indicating whether or not an apparatus has been paged, and wherein the paging message additionally includes at least one of the following that is common for a plurality of apparatuses:
a time-frequency resource allocation for transmitting the information;
an indication of which one or more channel properties are to be reported as part of the information;
an indication of one or more aggregation levels (ALs) to be used for a subsequent downlink control channel transmission;
sensing information related to a sensing operation;
quasi co-location (QCL) reference signal information; or
an indication of timing adjustment (TA) for an uplink transmission.

7. The method of claim 1, further comprising receiving a low-power wakeup signal (LP-WUS) or a reference signal that at least one of:
triggers an apparatus to switch to a different transceiver;
indicates a location of time-frequency resources in a downlink control channel used to receive a paging notification; or
indicates one or more aggregation levels (ALs) for the downlink control channel used to receive the paging notification.

8. An apparatus comprising:
at least one processor coupled to memory storing processor-executable instructions that, when executed by the at least one processor, cause the apparatus to perform operations, the operations comprising:
waking from a sleep mode to perform a paging operation;
during the paging operation, measuring at least one channel property using a downlink signal, to obtain a measured at least one channel property; and
transmitting information to a device based on the measured at least one channel property.

9. The apparatus of claim 8, wherein the downlink signal is received on a first beam, and wherein measuring the at least one channel property using the downlink signal comprises performing per-beam measurement during the paging operation by:
measuring the at least one channel property for the first beam using the downlink signal received on the first beam, to obtain a measured at least one channel property for the first beam; and
for each beam of one or more other beams: receiving a corresponding downlink signal on that beam and measuring the at least one channel property for that beam using the corresponding downlink signal received on that beam, to obtain a measured at least one channel property for each of the one or more other beams, and
wherein the information transmitted is based on the measured at least one channel property for the first beam and the measured at least one channel property for each of the one or more other beams.

10. The apparatus of claim 8, wherein multiple downlink signals, including the downlink signal, are received during the paging operation, wherein the multiple downlink signals have a quasi co-location (QCL) relationship with each other, and wherein measuring the at least one channel property comprises measuring the at least one channel property using at least one of the multiple downlink signals.

11. The apparatus of claim 8, wherein the operations further comprise:
receiving a message configuring one or more paging operations, wherein the message further configures at least one of:
one or more wake-up periods during which the apparatus is to transmit the information based on the measured at least one channel property;
one or more paging occasions for which the apparatus is to transmit the information;
the at least one channel property that is to be measured;
which one or more channel properties are to be reported as part of the information;
a manner in which the information is to be transmitted; or
uplink time-frequency resources used to transmit the information; and
wherein the message configures the one or more paging operations by at least configuring at least one of:
one or more wake-up periods;
one or more sleep periods;
a paging discontinuous reception (DRX) cycle; or
one or more paging occasions in a wake-up period.

12. The apparatus of claim 8, wherein transmitting the information includes at least one of:
transmitting the information in an uplink control channel;
transmitting the information in an uplink data channel;
transmitting the information during a random access procedure;
transmitting the information in a wake up signal (WUS); or
transmitting the information in an uplink reference signal.

13. The apparatus of claim 8, wherein the operations further comprise:
receiving a paging message during the paging operation, wherein the paging message includes apparatus-specific information indicating whether or not the apparatus has been paged, and wherein the paging message additionally includes at least one of the following that is common for a plurality of apparatuses:
a time-frequency resource allocation for transmitting the information;
an indication of which one or more channel properties are to be reported as part of the information;
an indication of one or more aggregation levels (ALs) to be used for a subsequent downlink control channel transmission;
sensing information related to a sensing operation;
quasi co-location (QCL) reference signal information; or
an indication of timing adjustment (TA) for an uplink transmission.

14. The apparatus of claim 8, wherein the operations further comprise:
receiving a low-power wake up signal (LP-WUS) or a reference signal that at least one of:
triggers the apparatus to switch to a different transceiver;
indicates a location of time-frequency resources in a downlink control channel used to receive a paging notification; or
indicates one or more aggregation levels (ALs) for the downlink control channel used to receive the paging notification.

15. A method comprising:
transmitting a downlink signal during a paging operation; and
receiving information from an apparatus, the information being based on at least one channel property that was measured by the apparatus using the downlink signal.

16. The method of claim 15, wherein the downlink signal is transmitted on a first beam, and a corresponding downlink signal is transmitted on each beam of one or more other beams, and wherein the information received from the apparatus is based on the at least one channel property measured by the apparatus for the first beam and the at least one channel property measured by the apparatus for each of the one or more other beams.

17. The method of claim 15, wherein multiple downlink signals, including the downlink signal, are transmitted during the paging operation, wherein the multiple downlink signals have a quasi co-location (QCL) relationship with each other, and wherein the at least one channel property that was measured by the apparatus was measured using at least one of the multiple downlink signals.

18. The method of claim 15, further comprising:
transmitting a message configuring one or more paging operations, wherein the message further configures at least one of:
one or more wake-up periods during which the apparatus is to transmit the information based on the at least one channel property that was measured by the apparatus;
one or more paging occasions for which the apparatus is to transmit the information;
the at least one channel property that is to be measured;
which one or more channel properties are to be reported as part of the information;
a manner in which the information is to be transmitted; or
uplink time-frequency resources used to transmit the information, and
wherein the message configures the one or more paging operations by at least configuring at least one of:
one or more wake-up periods;
one or more sleep periods;
a paging discontinuous reception (DRX) cycle; or
one or more paging occasions in a wake-up period.

19. The method of claim 15, further comprising transmitting a paging message during the paging operation, wherein the paging message includes apparatus-specific information indicating whether or not the apparatus has been paged, and wherein the paging message additionally includes at least one of the following that is common for a plurality of apparatuses:
a time-frequency resource allocation to be used for transmitting the information; an indication of which one or more channel properties are to be reported as part of the information;
an indication of one or more aggregation levels (ALs) to be used for a subsequent downlink control channel transmission;
sensing information related to a sensing operation;
quasi co-location (QCL) reference signal information; or
an indication of timing adjustment (TA) for an uplink transmission.

20. The method of claim 15, further comprising:
transmitting a low power-wake up signal (LP-WUS) or a reference signal that at least one of:
triggers the apparatus to switch to a different transceiver;
indicates a location of time-frequency resources in a downlink control channel used by a device to transmit a paging notification; or
indicates one or more aggregation levels (ALs) for the downlink control channel used by the device to transmit the paging notification.
